(19) United States
(12) Patent Application Publication
(10) Pub. No.: US 2005/0255315 A1
(43) Pub. Date: Nov. 17, 2005

(54) Oxide nanostructure, method for producing same, and use thereof

(76) Inventors: Shinsuke Yamanaka, Ashiya-shi (JP); Tsuyoshi Hamaguchi, Minoo-shi (JP); Masayoshi Uno, Kyoto-shi (JP); Ken Kurosaki, Minoo-shi (JP); Hiroaki Muta, Minoo-shi (JP); Kouichi Kugimiya, Toyonaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/540,231

(22) PCT Filed: Dec. 12, 2003
(86) PCT No.: PCT/JP03/15961

§ 371 Date: Aug. 1, 2005

(30) Foreign Application Priority Data
Dec. 21, 2002 (JP) 2002-383495
Jul. 22, 2003 (JP) 2003-277714
Oct. 21, 2003 (JP) 2003-360719

(51) Int. Cl. C01G 19/02

(52) U.S. Cl. 428/357; 423/618; 423/610

(57) ABSTRACT

The present invention provides a method of preparing directly a desired nano-structure of oxide without electrolyzing the target oxide, a nano-structure having structural resistance and various useful uses of the nano-structure. Into a solution containing a fluoride complex ion comprising metal element of the target oxide in which the metal is at least one selected from the group consisting of transition metal elements, group IA elements, group IIA elements, group IIIB elements, group IVB elements, group VB elements and group VIB elements, a template having nano-structure made from oxide is immersed, and the reaction condition is adjusted to substitute oxide of the template with the target oxide.

### BACKGROUND OF THE INVENTION

1. Field of the Invention

The present invention relates to an oxide nano-structure represented by an oxide nano-hole array, an oxide nano-hole array with a substrate, an oxide nano-rod and an oxide nano-hole, and a preparation method thereof and use thereof.

2. Description of the Related Art

Only anodized aluminum oxide (anodized alumina) has been known as a conventional oxide nano-structure material. As another oxide nano-structure material, proposed are porous TiO₂ which is formed by transcribing the microstructure of an anodized alumina [Jpn. J. Appl. Phys. Vol. 31 (1992) pp. L1775-L1777 Part 2, No. 12B, 15 Dec. 1992], and a nano-structure in which the microstructure of TiO₂ surface is prepared by photoelectrochemical etching [“Control of the microstructure on TiO₂ surface by photoelectrochemical etching”, the 18^{th} conference on Solid and Surface Photochemistry (published on Nov. 29, 1999)].

However, the former method has problems in that since it is a method of transcribing the microstructure of the anodized alumina, productivity is poor, and since the thickness of the microstructure formed is about 2 to 3 μm, it is not enough to be used as various functional elements of devices. On the other hand, the latter method has problems in that it is applied to only a TiO₂ material that is subjected to a photoelectrochemical reaction, and further it requires a high temperature of 1300° C. and a long time of 6 hours, which leads to a problem of productivity.

### SUMMARY OF THE INVENTION

Therefore, the present inventors have studied intensively for the purpose of providing a method of preparing directly a desired oxide nano-structure, not processing the target oxide, and as results, found that if the nano-structure of an anodized alumina, which is easy to control nano-structure by the anodization condition, is used as a template, it is possible to easily prepare nano-structure of the target oxide by a specific substitution reaction. Herein, the nano-structure of the conventional anodized alumina is in a state that pores 2 are regularly extended on one surface of a template 1 as shown in FIG. 1, whereas the oxide nano-structure according to the present invention is, for example, that tubular bodies 4 are arranged like a bundle as shown in FIG. 2.

Furthermore, the oxide nano-structure according to the invention can be not only the above-mentioned oxide nano-hole array, but also an oxide nano-hole array with a substrate (FIG. 3), an oxide nano-rod (FIG. 4(a)) or an oxide nano-hole (nano-needle) (FIG. 5) by the structure of the template used and the like on the basis of the substitution method. Specifically, if a template in which aluminum is stacked on the substrate and this is anodized, is used as a starting material, it is possible to prepare an oxide nano-tube array with a substrate (FIG. 3) by subjecting the template to a substitution reaction. Furthermore, by carrying out the above-mentioned substitution reaction under conditions that the precipitation reaction of the target oxide is predominant over the dissolution reaction of oxide of the template, and further by dissolving the anodized alumina remaining in the nano-structure, nano-rods (FIG. 4(c)), which are separated from each other, can be obtained. Furthermore, it has been found that separated oxide nano-holes (nano-needles) (FIG. 5) can also be obtained by dissolution of the remaining anodized alumina for the above-mentioned oxide nano-hole array.

Therefore, the first object of the present invention is to provide a nano-structure such as a nano-hole array, a nano-hole array with a substrate, a nano-rod, a nano-hole (nano-needle) and the like of various oxides having the structural resistance, without being limited to the metal oxide nano-structure which is suitable for the electrolytic method as in the conventional method.

Furthermore, the second object of the invention is to provide a method of preparing a nano-structure of various oxides by substitution reactions of oxides using a template without electrolyzing various metals.

Still further, such nano-structure can be used for various broad uses depending on the construction of the structure and a kind of oxide. Therefore, the third object of the invention is to provide various useful uses of the oxide nano-structure.

In the specification, the oxide nano-structure refers to an oxide nano-hole array, an oxide nano-hole array with a substrate, an oxide nano-rod or an oxide nano-hole (nano-needle), which is formed by the substitution method of the invention. The nano-hole (nano-rod) array refers to that tubular (cylindrical) nano-holes (nano-rods) are arranged like a bundle, and the nano-needle refers to a nano-hole which is in a state separated from the nano-hole array and has a pore diameter of 10 to 500 nm. The template refers to a starting oxide mold material, and a shape or structure which can be suitably selected by the shape or structure of the final target oxide in the method of the invention. Furthermore, the aspect ratio refers to a length of an oxide nano-structure divided by its diameter. Still further, stability constant refers to a measure representing stability of the complex in a solution. For example, in a reaction in which a ligand A and a metal ion B produce a complex C,
A+B→C
the stability constant of the complex C is defined as [C]/([A][B]). Herein, [ ] represents each concentration.

The invention has been achieved by finding that the nano-structure of aluminum oxide is substituted with oxide of a metal element which composes a fluoride complex in an aqueous solution containing a fluoride complex ion. Therefore, the invention is to provide a nano-structure of oxide or complex oxide of a metal element in which the metal element is at least one selected from the group consisting of transition metal elements, group IA elements, group IIA elements, group IIIB elements, group IVB elements, group VB elements and group VIB elements and has an ability to compose a fluoride complex ion, and a stability constant of the fluoride complex is smaller than that of aluminum fluoride.

As described below, since the oxide nano-structure formed in the invention is realized by concomitant progress of the dissolution reaction of the aluminum oxide of the template in an aqueous solution, and the precipitation reaction from the fluoride complex ion of the target oxide contained in the aqueous solution, the above-mentioned target oxide preferably meets conditions that the metal element is at least one selected from the group consisting of transition metal elements, group IA elements, group IIA elements, group IIIB elements, group IVB elements, group VB elements and group VIB elements and has an ability to compose a fluoride complex ion, and at the same time, oxide of the template is easier to form a fluoride ion than the target oxide, that is, a stability constant of the fluoride complex is smaller than that of aluminum fluoride.

If the above-mentioned substitution reaction is carried out using the nano-structure of alumina formed by anodization as a template, it is possible to provide an oxide nano-hole array in which penetrating pores of the nano-holes are arranged like a bundle.

Furthermore, if the above-mentioned substitution reaction is carried out using one prepared by forming an aluminum layer on a substrate and anodizing the stacked body as a template, it is possible to prepare an oxide nano-hole array with a substrate.

Still further, if a nano-structure of aluminum oxide is substituted with a metal element oxide composing a fluoride complex in an aqueous solution containing a fluoride complex ion, and it is controlled that the precipitation reaction of the target oxide is greater than the dissolution reaction rate of the anodized alumina which is a template, it is possible to form a nano-structure as a rod shape, not as a hole shape.

Still further, by dissolution of the anodized alumina remaining on the circumference of the nano-hole array, it is also possible to make a nano-hole array arranged like a bundle to nano-holes in a separated state (nano-needle).

The above-mentioned oxide nano-structure can be prepared as a stack structure of the first oxide and the second oxide in which the metal element is at least one selected from a group consisting of transition metal elements, group IA elements, group IIA elements, group IIIB elements, group IVB elements, group VB elements and group VIB elements, in which the metal element has an ability to compose a fluoride complex ion. It is preferable that the first oxide is formed by the first substitution reaction and the second oxide is formed by the second substitution reaction. For example, specific examples of the stacked oxide nano-structure include stacked oxide nano-hole arrays in which a TiO₂ nano-hole array and a SnO₂ nano-hole array are stacked.

Still further, it is also possible to prepare an oxide nano-hole array in which fine metal particles are contained in oxide and the penetrating pores of the nano-holes are arranged like a bundle. Further, it is also possible to form an oxide nano-hole array which is made from a complex oxide of the first oxide and the second oxide, in which the penetrating pores of the nano-holes are arranged like a bundle. For example, specific examples of the fine metal particle dispersion include a TiO₂ nano-hole array comprising at least one selected from the group consisting of Au, Ag, Pt and Cu.

Furthermore, specific examples of the complex oxide nano-hole array include a La₂Ti₂O₇ nano-hole array. If a solution is used in which fluoride complex ions of two or more metal elements which form the target complex oxide exist at the same time, it is possible to prepare a complex oxide nano-hole array.

It is possible to prepare a stack structure, a structure containing metal fine particles or a complex oxide structure for a nano-hole array with a substrate, a nano-rod or a nano-needle in the same manner as in a nano-hole array.

Since the nano-structure according to the invention is prepared by substituting with the target oxide using a template of anodized alumina, it is characterized in that aluminum oxide of the template remains in an amount of 0.1 vol % relative to the total oxides.

If it is necessary to remove the remaining aluminum oxide, it is possible to use a method of subjecting the anodized alumina to dissolution by conducting etching with phosphoric acid, NaOH and the like.

It is possible to prepare a metal nano-hole array, a nitride nano-hole array or a carbide nano-hole array by a reduction treatment, a nitriding treatment and a carbonization treatment of the oxide nano-structure according to the invention.

By performing a suitable heat treatment, the heat-treated oxide nano-hole array can have strength, improved crystallinity and improved performance. Since nitride and carbide have high hardness, the nitride nano-hole array and carbide nano-hole array can be used as a mold for nano-structure transcription. Furthermore, they can be also used as a filter for electric heating since many of them have electrical conductivity. The metal nano-hole array can be used as processed into various shapes since a metal has high workability. Furthermore, it can be used as a material for an electrode due to good electrical conductivity. Not only for the nano-hole array, but also for other nano-structures, the above-mentioned post treatment can be conducted if necessary.

According to the invention, a nano-hole array is obtained in which the penetrating pore of the nano-hole has the length of 50 μm or more. Since the aspect ratio of the nano-hole is 100 or more, it is useful as a functional material of various devices.

Furthermore, for the nano-hole array with a substrate, an oxide nano-rod and an oxide nano-hole (nano-needle), obtained is one wherein the length of the nano-structure is 1 μm or more and the aspect ratio is 5 or more.

For the oxide nano-needle, it is useful in micro-injection, micro-operation, micro-adhesion and the like as described below since the pore diameter is 10 to 500 nm.

The invention provides a method of preparing an oxide nano-structure, which is characterized by comprising a step of preparing a template which is made from oxide and has a nano-structure, a step of preparing a solution which contains a fluoride complex ion of the metal element of the target oxide, and a step of immersing the oxide template into the solution to substitute a part or the whole of the oxide template with the target oxide.

According to the invention, it is possible to prepare the target oxide nano-structure by immersing the nano-structure of the template into the fluoride complex solution to substitute it with the target oxide. The above-mentioned fluoride complex solution is preferably a tin fluoride complex solution, a titanium fluoride complex solution, a zirconium fluoride complex solution, an iron fluoride complex solution or a zinc fluoride complex solution, but is not limited to them.

Furthermore, if a template is used in which is obtained by an anodization treatment of aluminum stacked on the metal or non-metal substrate, and a substitution reaction is carried out in the same manner as described above, it is possible to obtain an oxide nano-hole array with a substrate.

Furthermore, in the method of preparing an oxide nano-rod, it is possible to prepare an oxide nano-rod of a cylindrical shape, not a hole shape by controlling the reaction temperature, a scavenger and the like so that the precipitation reaction rate of the target oxide (MF₆²⁻+2H₂O⇄MO₂+4HF+2F⁻) is greater than the dissolution reaction rate of the anodized alumina (Al₂O₃+12F⁻+12H⁺→2H₃AlF₆+3H₂O). This is due to the fact that by elevating the precipitation reaction rate of the oxide, the target oxide gets blocked in the pore of the anodized alumina. Herein, it is possible to make the precipitation reaction rate of the target oxide greater than the dissolution reaction rate of the anodized alumina by elevating the reaction temperature, by administering a lot of a scavenger, and by administering a scavenger which has good scavenging activity. The above-mentioned scavenger scavenges the fluoride ion in the solution, which leads the above-mentioned precipitation reaction toward the right direction. The scavenger to be used is preferably boric acid (H₃BO₃), an aluminum plate and the like.

The reaction temperature and the kind or the amount of the scavenger are varied depending on the material composing the nano-rod. For example, the preparation condition for a TiO₂ nano-rod is suitably about 20° C. of the reaction temperature, H₃BO₃ as a scavenger and about 3 hours of the reaction time.

Still further, by making the nano-rod array which has been prepared by the above-mentioned method in a separated state from each other, respectively, it is possible to prepare an oxide nano-rod. When it is necessary to dissolve the anodized alumina remaining between the rods, it is desired to immerse the rod into a solution which has no reaction to the target oxide, but has reaction only to the remaining anodized alumina. The nano-rod in a separated state is useful as a dispersion material into a high molecular resin and the like. If the aspect ratio is increased, anisotropy of a dispersion material is increased and thus it is possible to increase strength more than that of the complex material in which carbon is dispersed in the high molecular resin.

Furthermore, for a method of preparing an oxide nano-hole (nano-needle) as well, it is possible to make the above-mentioned oxide nano-hole array to an oxide nano-hole (nano-needle) which is separated from each other by dissolution of the anodized alumina remaining in the oxide nano-hole array.

The target oxide can be substituted with oxide of the template if the metal element is one of transition metal elements, group IA elements, group IIA elements, group IIIB elements, group IVB elements, group VB elements and group VIB elements, and the metal element has an ability to compose a fluoride complex ion.

If the concentration of the above-mentioned fluoride complex ion in an aqueous solution is 0.1 mmol/l or more, it is possible to obtain a preferable substitution reaction rate.

The above-mentioned fluoride complex ion is prepared as an aqueous solution thereof in which the fluoride complex ion is present in the formula: MFₓ^{y-} (wherein M represents one of transition metal elements, group IA elements, group IIA elements, group IIIB elements, group IVB elements, group VB elements and group VIB elements, x represents the number of fluorine atoms and y represents valency).

It is considered that the above-mentioned fluoride complex ion MFₓ^{y-} is in an equilibrium state with hydroxide in the aqueous solution, and formation of the target oxide or hydroxide which is its precursor occurs at the same time with the dissolution of Al₂O₃. Therefore, the target oxide may be selected from the group consisting of metal elements which form hydroxide by hydrolysis of the above-mentioned fluoride complex ion in the solution.

The substitution reaction step of the above-mentioned oxide of the template with the target oxide is carried out, for example, by the dissolution reaction of oxide of the template and the precipitation reaction of the target oxide as shown below when the fluoride complex ion MFₓ^{y-} is MF₆²⁻.

The precipitation reaction of the target oxide:
MF₆²⁻+2H₂O [symbol] MO₂+4HF+2F⁻
(MF₆²⁻+4H₂O [symbol] M(OH)₄+4HF+2F⁻,
M(OH)₄→MO₂+2H₂O)

The dissolution reaction of oxide of the template:
Al₂O₃+12F⁻+12H⁺→2H₃AlF₆+3H₂O

In the methods of preparing a nano-hole array, a nano-hole array with a substrate and a nano-needle, the above-mentioned substitution reaction is preferably carried out under atmospheric pressure temperature in the range of 0° C. to 80° C., preferably 5° C. to 40° C. If the temperature is less than 0° C., the substitution reaction rate is not enough, and if the temperature is more than 80° C., the particle size of the precipitated oxide is not homogenous, which leads to difficulty in shape control.

In the method of preparing a nano-rod, the above-mentioned substitution reaction is preferably carried out under the atmospheric pressure in the range of 0° C. to 80° C., preferably 20° C. to 80° C. To make the precipitation reaction of the target oxide predominant over the dissolution reaction of oxide of the template, it is preferable to elevate the temperature at the time of the substitution reaction more than that of preparing the nano-hole array, the nano-hole array with a substrate and the nano-needle, or to mix a scavenger in the solution.

The substitution reaction according to the invention can be promoted by carrying out it under application of any of light irradiation, radiation irradiation and ultrasonic irradiation.

Herein, the light irradiation refers to injecting any light during the reaction to give energy from the outside. Thereby, it is possible to carry out promotion of the reaction and control of crystal orientation and crystallinity.

Furthermore, the radiation irradiation refers to injecting any radiation during the reaction to give energy from the outside. Thereby, it is possible to carry out promotion of the reaction and control of crystal orientation and crystallinity. Generally, it is possible to give higher energy than light irradiation.

The ultrasonic irradiation refers to injecting ultrasonic wave with stirring during the reaction to give energy from the outside. Thereby, it is possible to carry out promotion of the reaction and control of crystal orientation and crystallinity, and also maintain homogenous reaction.

The typical oxide causing the substitution reaction in an aqueous solution containing a fluoride complex ion includes aluminum oxide. Therefore, it has been found in the invention that it is preferable to use a template made from aluminum oxide in which the nano-structure is formed by an anodization treatment (anodized alumina). Furthermore, when preparing an oxide nano-hole with a substrate or an oxide nano-rod with a substrate (FIG. 4(b)), a template may be also used in which an aluminum layer is formed on the substrate and the stacked product is anodized.

The above-mentioned nano-structure of the template may be a state that the pores 102 are regularly extended on one surface of the template 101 as shown in the schematic sectional view of FIG. 6(a) or a state that the pores 104 are present as penetrated from one surface to the other surface of the template 103 as shown in the schematic sectional view of FIG. 6(b) or a structure that the template 105 has the pores 106 of a diameter of 200 nm on one surface and has the pores 107 of a diameter of 20 nm on the other surface as shown in the schematic sectional view of FIG. 6(c).

Furthermore, in the method of preparing the oxide nano-hole array with a substrate, a template in which a substrate is arranged, is used as shown in FIG. 7(a) or FIG. 7(b).

FIG. 7(a) and FIG. 7(b) show ones in which the substrate 205 is arranged on the templates of FIG. 6(a) and FIG. 6(b), respectively.

The above-mentioned nano-structure of the template can be adjusted by anodization conditions such as a kind of electrolytic solution, the concentration of an electrolytic solution, an electrolytic voltage and the like. For example, the electrolytic voltage is proportional to the pore diameter, and if the electrolytic voltage is 5 to 250 V, the diameter is 10 to 500 nm. Furthermore, the kind of the electrolytic solution may be changed depending on the magnitude of the electrolytic voltage. Sulfuric acid is used as an electrolytic solution at an electrolytic voltage of 5 to 30 V, oxalic acid is used as an electrolytic solution at an electrolytic voltage of 30 to 120 V and phosphoric acid is used as an electrolytic solution at an electrolytic voltage of 120 to 250 V.

The oxide nano-structure prepared by the method of the invention can be subjected to various post treatments. For example, it is possible to sinter the oxide nano-structure by a heating treatment to improve the strength. Furthermore, it is possible to reduce the oxide nano-structure to prepare a metal nano-structure. Still further, it is also possible to carry out a nitriding treatment of the oxide nano-structure to prepare a nitride nano-structure. Still further, it is also possible carbonize the oxide nano-structure to prepare a carbide nano-structure.

Herein, conditions for the above-mentioned heating treatment, reduction treatment, nitriding treatment and carbonization treatment are preferably selected as follows:

Heating treatment condition: Irradiation of electromagnetic wave at 100 W to 500 W for 1 minute to 30 minutes, preferably, at 500 W for 10 minutes. Then, sintering at any temperature.

Reduction treatment condition: Irradiation of electromagnetic wave at 100 W to 500 W for 1 minute to 30 minutes, preferably, at 500 W for 10 minutes. Then, sintering under vacuum or reduction atmosphere.

Nitriding treatment condition: Heating the oxide nano-structure under vacuum or reduction atmosphere to reduce it to a metal nano-structure, followed by reacting it in nitrogen gas or ammonia gas at high temperature to give a nitride nano-structure. Alternatively, mixing the nano-structure with carbon, and reacting it in nitrogen gas or ammonia gas at high temperature.

Carbonization treatment condition: Heating the oxide nano-structure under vacuum or reduction atmosphere to reduce it to a metal nano-structure, followed by mixing it with carbon, and reacting it at high temperature to give a carbide nano-structure.

Uses of the oxide nano-structure according to the invention are as follows:

i) Oxide Nano-Hole Array

1) For a nano-hole array which is made from TiO₂, ZnO, SnO₂, SiO₂ or a mixture thereof, or a complex oxide thereof, in which the penetrating pores of the nano-holes, which have the length of 50 μm or more and the aspect ratio of 100 or more, are arranged like a bundle, it is useful as a material for a photocatalyst. Especially, high photocatalyst activity is obtained from having broad specific surface area.

2) The above-mentioned nano-hole array is useful as a material for a visible light-responsive photocatalyst by dispersing at least one selected from Ag, Pt and Cu fine particles within the wall. Especially, high photocatalyst activity is obtained from having broad specific surface area.

3) The above-mentioned nano-hole array is also useful as a nano-hole array for an energy saving photocatalyst, by supporting WO₃ in the nano-hole. Especially, a novel material for a photocatalyst is provided in which WO₃ in the nano-hole saves light, and further catalytic property can be obtained by the saved light.

4) For a nano-hole array which is made from TiO₂ or SiO₂, in which the penetrating pores of the nano-holes, which have the length of 50 μm or more and the aspect ratio of 100 or more, are arranged like a bundle, it is useful as a nano-hole array for photochromism by supporting Ag. Especially, since Ag can be supported in large amount, it is possible to increase photochromism function which “preserves the color”.

5) For a nano-hole array which is made from TiO₂, ZnO, SnO₂ or a mixture thereof, or a complex oxide thereof, in which the penetrating pores of the nano-holes, which have the length of 50 μm or more and the aspect ratio of 100 or more, are arranged like a bundle, it is useful as a nano-hole array for a dye-sensitizing solar cell. Especially, it is possible to elevate reactivity rapidly by increasing the contact area with the electrolytic solution.

6) For a nano-hole array which is made from V₂O₅ or TiO₂, in which the penetrating pores of the nano-holes, which have the length of 50 μm or more and the aspect ratio of 100 or more, are arranged like a bundle, it is useful as a positive electrode of a lithium-ion battery. Since the reaction area in the positive electrode can be increased, it is possible to rapidly improve performance of the secondary battery.

7) For a nano-hole array which is made from ZnO or TiO, in which the penetrating pores of the nano-holes, which have the length of 50 μm or more and the aspect ratio of 100 or more, are arranged like a bundle, it is useful as a material for thermoelectric conversion. With preserving low thermal conductivity, it is possible to improve only electrical conductivity.

8) For a nano-hole array which is made from ZnO, TiO₂, SnO₂, Fe₂O₃ or ZrO₂, in which the penetrating pores of the nano-holes, which have the length of 50 μm or more and the aspect ratio of 100 or more, are arranged like a bundle, it is useful as a material for thermoelectric conversion if burying the nano metal in the nano-hole. With preserving low thermal conductivity, it is possible to improve only electrical conductivity.

9) For a nano-hole array which is made from TiO, TiO₂, ZnO, SnO₂ or a mixture thereof, or a complex oxide thereof, in which the penetrating pores of the nano-holes, which have the length of 50 μm or more and the aspect ratio of 100 or more, are arranged like a bundle, it is useful as a nano-hole array for a gas sensor. Since the specific surface area is great, it helps to increase the adsorption area of gas molecules and improve the sensor property.

10) For a nano-hole array which is made from SnO₂, in which the penetrating pores of the nano-holes, which have the length of 50 μm or more and the aspect ratio of 100 or more, are arranged like a bundle, it is useful as a nano-hole array for a material for a humidity sensor.

11) For a nano-hole array which is made from TiO, TiO₂, ZnO, SnO₂ or a mixture thereof, or a complex oxide thereof, in which the penetrating pores of the nano-holes, which have the length of 50 μm or more and the aspect ratio of 100 or more, are arranged like a bundle, it is useful as a nano-hole array for an odor sensor.

12) For a nano-hole array which is made from TiO₂, in which the penetrating pores of the nano-holes, which have the length of 50 μm or more and the aspect ratio of 100 or more, are arranged like a bundle, it is useful as a nano-hole array for a light sensor.

13) For a nano-hole array which is made from TiO₂, in which the penetrating pores of the nano-holes, which have the length of 50 μm or more and the aspect ratio of 100 or more, are arranged like a bundle, it is useful as a nano-hole array for photonic crystal.

14) For a nano-hole array which is made from oxide other than Al₂O₃, in which the penetrating pores of the nano-holes, which have the length of 50 μm or more and the aspect ratio of 100 or more, are arranged like a bundle, it is useful as a nano-hole array for high temperature filter having excellent durability. For example, it is useful as a filter for dioxins.

15) For a nano-hole array which is made from complex oxide of ZrO₂ and Y₂O₃, in which the penetrating pores of the nano-holes, which have the length of 50 μm or more and the aspect ratio of 100 or more, are arranged like a bundle, it is useful as a nano-hole array for an electrolytic material such as a solid oxide fuel cell and the like. The constitution unit of the fuel cell is a single cell in which the electrolyte is interposed between two electrodes. Though the nano-structure according to the invention can be classified into several types according to the kind of the electrolyte to be used, it can be applied to a solid oxide fuel cell. As the electrolyte of the solid oxide fuel cell, thin film of ZrO₂—Y₂O₃ (Yttria Stabilized Zirconia; YSZ) is used. The YSZ nano-hole array of the present invention has a feature that it can be used at high temperature without a catalyst since the electrolyte is oxide, and therefore, it can be used as an electrolyte material of the solid oxide fuel cell.

16) For a nano-hole array which is made from oxide other than Al₂O₃, in which the penetrating pores of the nano-holes, which have the length of 50 μm or more and the aspect ratio of 100 or more, are arranged like a bundle, it is useful as a nano-hole array for a filter for separation of various gases and various liquids and sterilization. For example, it is useful as a filter for separation and sterilization of medical gas, and additionally, separation of cells, separation and degradation of substances which is hard to be treated such as environmental hormone and the like, separation and immobilization of FP (a fission product) and purification of various liquid wastes.

Furthermore, nano-hole arrays of various oxides are useful as bio-filter. For example, for the size of primary viruses, herpes virus has a diameter of 120 nm to 200 nm, vaccinia virus (smallpox vaccine) has a diameter of 200 nm to 300 nm, and influenza virus has a diameter of 80 nm to 120 nm. It can be said that the nano-hole array (the pore diameter of about 200 nm) has a size suitable for separation of such viruses.

Furthermore, for those having a photocatalyst function like a TiO₂ nano-hole array, disinfection function by a photocatalyst can be also given in addition to the filter function. Thereby, it is possible to provide a filtering system which can remove all pathogenic microorganism including bacteria and virus. Furthermore, the pore diameter of the nano-hole array is also suitable for incubation of various viruses. It is also useful as incubator for incubating virus for experiment, specifically bioreactor. 17) For a nano-hole array which is made from oxide represented by the formula: MO_{b} (wherein M is Zr, Fe, Ni, Ti or Si. b is the number of oxygen atoms.), in which the penetrating pores of the nano-holes, which have the length of 50 μm or more and the aspect ratio of 100 or more, are arranged like a bundle, if it is an Li₂O supported material, it is useful as a material for CO₂ immobilization.

18) For a nano-hole array which is made from oxide represented by the formula: LiₐMO_{b} (wherein M is Zr, Fe, Ni, Ti or Si. a is the number of lithium atoms, and b is the number of oxygen atoms.), in which the penetrating pores of the nano-holes, which have the length of 50 μm or more and the aspect ratio of 100 or more, are arranged like a bundle, it is useful as a material for CO₂ immobilization.

19) For a nano-hole array which is made from stacked oxide comprising any one kind of combinations of Fe₂O₃ and ZrO₂, Fe₂O₃ and TiO₂, Fe₂O₃ and SnO₂, Fe₃O₄ and ZrO₂, Fe₃O₄ and TiO₂, and Fe₃O₄ and SnO₂, in which the penetrating pores of the nano-holes, which have the length of 50 μm or more and the aspect ratio of 100 or more, are arranged like a bundle, it is also useful as a nano-hole array for high density memory media.

ii) Oxide Nano-Hole Array with Substrate

20) For a nano-hole array with a substrate which is made from TiO₂, ZnO, SnO₂, SiO₂ or a mixture thereof, or a complex oxide thereof, in which the nano-hole, which has the length of 1 μm or more and the aspect ratio of 5 or more, is arranged like a bundle on the substrate, it is useful as a material for a photocatalyst. Especially, high photocatalyst activity is obtained from having broad specific surface area.

21) For a nano-hole array with a substrate which is made from TiO₂, ZnO, SnO₂, SiO₂ or a mixture thereof, or a complex oxide thereof, in which the nano-hole, which has the length of 1 μm or more and the aspect ratio of 5 or more, is arranged like a bundle on the substrate, by dispersing at least one selected from Ag, Pt and Cu fine particles within the wall, it is useful as a material for a visible light-responsive photocatalyst. Especially, high photocatalyst activity is obtained from having broad specific surface area.

22) For a nano-hole array with a substrate which is made from TiO₂ or SiO₂, in which the nano-hole, which has the length of 1 μm or more and the aspect ratio of 5 or more, is arranged like a bundle on the substrate, by being supported by Ag, it is useful as a nano-hole array for photochromism. Especially, since Ag can be supported in large amount, it is possible to increase photochromism function which “preserves the color”.

23) For a nano-hole array with a substrate which is made from TiO₂, ZnO, SnO₂ or SiO₂, in which the nano-hole, which has the length of 1 μm or more and the aspect ratio of 5 or more, is arranged like a bundle on the substrate, by supporting WO₃ in the nano-hole, it is also useful as a nano-hole array for an energy saving photocatalyst. Especially, a novel material for a photocatalyst is provided wherein WO₃ in the nano-hole saves light, and catalytic property can be obtained by the saved light.

24) For a nano-hole array with a substrate which is made from TiO₂, ZnO, SnO₂ or a mixture thereof, or a complex oxide thereof, in which the nano-hole, which has the length of 1 μm or more and the aspect ratio of 5 or more, is arranged like a bundle on the substrate, it is useful as a nano-hole array for a dye-sensitizing solar cell. Especially, it is possible to elevate reactivity rapidly by increasing the contact area with the electrolytic solution. Furthermore, the substrate can be also used as an electrode for collecting electricity.

25) For a nano-hole array with a substrate which is made from V₂O₅ or TiO₂, in which the nano-hole, which has the length of 1 μm or more and the aspect ratio of 5 or more, is arranged like a bundle on the substrate, it is useful as a positive electrode of a lithium-ion battery. Since the reaction area in the positive electrode can be increased and the substrate can have the function as an electrode for collecting electricity, it is possible to rapidly improve performance of the secondary battery.

26) For a nano-hole array with a substrate which is made from ZnO or TiO, in which the nano-hole, which has the length of 1 μm or more and the aspect ratio of 5 or more, is arranged like a bundle on the substrate, it is useful as a material for thermoelectric conversion. With preserving low thermal conductivity, it is possible to improve only electrical conductivity. Furthermore, the substrate can have the function as an electrode for collecting electricity.

27) For a nano-hole array with a substrate which is made from ZnO, TiO₂, SnO₂, Fe₂O₃ or ZrO₂, in which the nano-hole, which has the length of 1 μm or more and the aspect ratio of 5 or more, is arranged like a bundle on the substrate, in the nano-hole if burying the nano metal, it is useful as a material for thermoelectric conversion. With preserving low thermal conductivity, it is possible to improve only electrical conductivity. Furthermore, the substrate can have the function as an electrode for collecting electricity.

28) For a nano-hole array with a substrate which is made from TiO, TiO₂, ZnO, SnO₂ or a mixture thereof, in which the nano-hole, which has the length of 1 μm or more and the aspect ratio of 5 or more, is arranged like a bundle on the substrate, it is useful as a nano-hole array for gas sensor. Since the specific surface area is great, it helps to increase the adsorption area of gas molecules and improve the sensor property. Furthermore, the substrate can have the function as an electrode for collecting electricity.

29) For a nano-hole array with a substrate which is made from SnO₂, in which the nano-hole, which has the length of 1 μm or more and the aspect ratio of 5 or more, is arranged like a bundle on the substrate, it is useful as a material for humidity sensor. Furthermore, the substrate can have the function as an electrode for collecting electricity.

30) For a nano-hole array with a substrate which is made from TiO, TiO₂, ZnO, SnO₂ or a mixture thereof, in which the nano-hole, which has the length of 1 μm or more and the aspect ratio of 5 or more, is arranged like a bundle on the substrate, it is useful as a nano-hole array for odor sensor. Furthermore, the substrate can have the function as an electrode for collecting electricity.

31) For a nano-hole array with a substrate which is made from TiO₂, in which the nano-hole, which has the length of 1 μm or more and the aspect ratio of 5 or more, is arranged like a bundle on the substrate, it is useful as a nano-hole array for light sensor. Furthermore, the substrate can have the function as an electrode for collecting electricity.

32) For a nano-hole array with a substrate which is made from TiO₂, in which the nano-hole, which has the length of 1 μm or more and the aspect ratio of 5 or more, is arranged like a bundle on the substrate, it is useful as a nano-hole array for photonic crystal.

33) For a nano-hole array which is made from oxide represented by the formula: MO_{b} (wherein M is Zr, Fe, Ni, Ti or Si.), in which the nano-hole, which has the length of 1 μm or more and the aspect ratio of 5 or more, is arranged like a bundle, by being supported by Li₂O, it is useful as a material for CO₂ immobilization.

34) For a nano-hole array with a substrate which is made from oxide represented by the formula: LiₐMO_{b} (wherein M is Zr, Fe, Ni, Ti or Si. a is the number of lithium atoms, and b is the number of oxygen atoms.), in which the nano-hole, which has the length of 1 μm or more and the aspect ratio of 5 or more, arranged like a bundle, it is useful as a material for CO₂ immobilization.

35) For a nano-hole array with a substrate which is made from stacked oxide comprising any one kind of combinations of Fe₂O₃ and ZrO₂, Fe₂O₃ and TiO₂, and Fe₂O₃ and SnO₂, in which the nano-hole, which has the length of 1 μm or more and the aspect ratio of 5 or more, is arranged like a bundle, it is also useful as a nano-hole array for high density memory media.

iii) Oxide Nano-Rod

36) For a nano-rod which is made from TiO₂, ZnO, SnO₂, SiO₂ or a mixture thereof, or a complex oxide thereof, in which the length of the nano-rod is 1 μm or more and the aspect ratio is 5 or more, it is useful as a material for matrix reinforcement.

37) For a nano-rod which is made from TiO₂, ZnO, SnO₂, SiO₂ or a mixture thereof, or a complex oxide thereof, in which the length of the nano-rod is 1 μm or more and the aspect ratio is 5 or more, it is useful as a material for a photocatalyst. Especially, high photocatalyst activity is obtained from having broad specific surface area.

38) For a nano-rod which is made from TiO₂, ZnO, SnO₂, SiO₂ or a mixture thereof, or a complex oxide thereof, in which the length of the nano-rod is 1 μm or more and the aspect ratio is 5 or more, by dispersing at least one selected from Ag, Pt and Cu fine particles within the wall, it is useful as a material for a visible light-responsive photocatalyst. Especially, high photocatalyst activity is obtained from having broad specific surface area.

iv) Oxide Nano-Hole (Oxide Nano-Needle)

39) For a nano-hole (nano-needle) which is made from oxide other than Al₂O₃, in which the length of the nano-hole is 1 μm or more and the diameter is 10 nm to 500 nm, and the aspect ratio is 5 or more, it is useful as a needle for micro-injection. Especially, a nano-hole (nano-needle) made from TiO₂ can sterilize the inner and outer surface of the needle using the photocatalyst function. Herein, micro-injection refers to taking out or in directly substances such as gene and the like by manipulation of a single cell. With using the oxide nano-needle according to the invention, correct cell manipulation can be carried out more accurately.

40) For a nano-hole (nano-needle) which is made from oxide other than Al₂O₃, in which the length of the nano-hole is 1 μm or more and the diameter is 10 nm to 500 nm, and the aspect ratio is 5 or more, it is useful as a needle for micro-operation. By using the nano-needle according to the invention instead of the conventional glass capillary, pinpoint treatment for smaller area is enabled. Furthermore, since a nano-needle made from TiO₂ can sterilize the inner and outer surface of the needle similarly to the above-mentioned micro-injection, it can be suitably used for micro-operation. According to the nano-needle according to the present invention, needles having uniform diameter can be produced largely in short time, which reduces burdens for patients from excessive administration.

41) For a nano-hole (nano-needle) which is made from oxide other than Al₂O₃, in which the length of the nano-hole is 1 μm or more and the diameter is 10 nm to 500 nm, and the aspect ratio is 5 or more, it is useful as a needle for micro-adhesion. With using a nano-needle having a diameter of 10 nm to 500 nm, it is possible to apply a trace amount of an adhesive more correctly than the present. Thereby, it can be also used for adhesion of hard disk head and adhesion of optical micro-lens in the field of semiconductor and mechanics. Furthermore, instruments and artificial organ in the medical field, artificial satellite in the field of aerospace and the like can be also more minimized by this nano-needle.

Effects More Effective than Those of the Conventional Technique

According to the invention, the target oxide nano-structure can be easily prepared by immersing the nano-structure of the template in a certain aqueous solution and substituting the above-mentioned nano-structure of the template with the target oxide. According to the invention, it is possible to prepare the nano-structure of various oxides, so it is possible to provide a nano-structure which is useful as various functional materials of devices and various filters and the like.

### BRIEF DESCRIPTION OF THE DRAWINGS

FIG. 1 is a schematic view of an anodized alumina nano-structure;

FIG. 2 is a schematic view of a nano-hole array of oxide according to the present invention;

FIG. 3 is a schematic view of the nano-hole array of oxide with a substrate according to the invention;

FIG. 4A is a schematic view of the nano-rod array of oxide, FIG. 4B is a schematic view of the nano-rod array of oxide wherein a substrate is arranged, and FIG. 4C is a schematic view of the nano-rods which are separated from the nano-rod array;

FIG. 5 is a schematic view of the nano-hole of oxide (nano-needles of oxide) according to the invention;

FIGS. 6A to 6C are schematic sectional views of the templates which are used in the method of preparing the nano-hole array of oxide, the nano-rod of oxide and the nano-needle of oxide according to the invention;

FIGS. 7A and 7B are schematic sectional views of the templates which are used in the method of preparing the nano-hole array of oxide with a substrate according to the invention;

FIGS. 8A to 8D are conceptual views showing the preparation process of the nano-hole array of oxide with a substrate;

FIGS. 9A to 9E are for the conventional transcription techniques;

FIG. 10 is a conceptual view showing the substitution reaction process;

FIG. 11 is a conceptual view when the nano-hole array of titanium oxide of the invention is applied to wet solar cell;

FIG. 12 is a conceptual view when the titanium oxide nano-hole array of the invention is applied to a material for a photocatalyst;

FIG. 13 is a conceptual view when the nano-hole array of zinc oxide of the invention is applied to a material for thermoelectric conversion;

FIG. 14 is a conceptual view when the nano-hole array of vanadium oxide of the invention is applied to a positive electrode of a lithium ion battery;

FIG. 15 is a conceptual view of micro-injection;

FIG. 16 is a conceptual view of micro-operation;

FIG. 17 is a conceptual view of micro-adhesion;

FIG. 18 is a schematic view of the nano-needle of oxide attached to a glass capillary;

FIG. 19 is an observation image of a scanning electron microscope (SEM) for a SnO₂ nano-hole array;

FIG. 20 is an observation image of SEM for a TiO₂ nano-hole array;

FIG. 21 is an observation image of SEM for a ZrO₂ nano-hole array;

FIG. 22 is an observation image of SEM for a FeOOH nano-hole array;

FIG. 23 is an observation image of SEM for a ZnO nano-hole array;

FIG. 24 is an observation image of SEM for a TiO₂ nano-hole array with a substrate;

FIG. 25 is an observation image of SEM for a SnO₂ nano-rod which is prepared without mixing a scavenger;

FIG. 26 is an observation image of SEM for a SnO₂ nano-rod which is prepared with mixing a scavenger;

FIG. 27 is an observation image of SEM for a TiO₂ nano-rod which is prepared without mixing a scavenger;

FIG. 28 is an observation image of SEM for a ZnO nano-rod which is prepared without mixing a scavenger;

FIG. 29 is an observation image of SEM for a TiO₂ nano-needle; and

FIG. 30 is an observation image of SEM for a TiO₂ nano-needle.

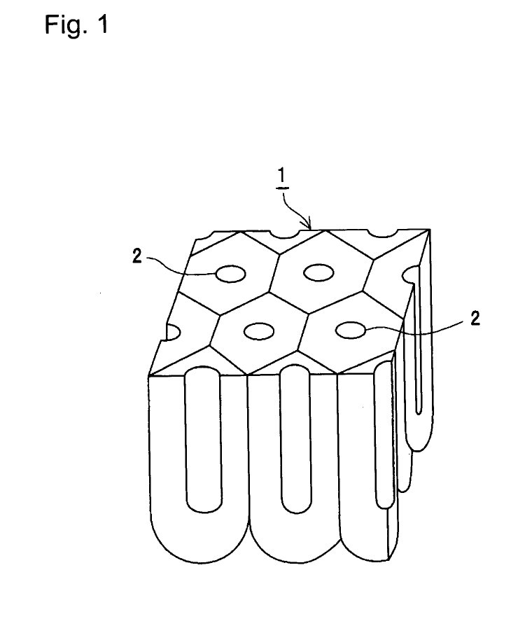

### DESCRIPTION OF THE PREFERRED EMBODIMENTS

The present invention is carried out by the following process.

(1) Preparation of Template

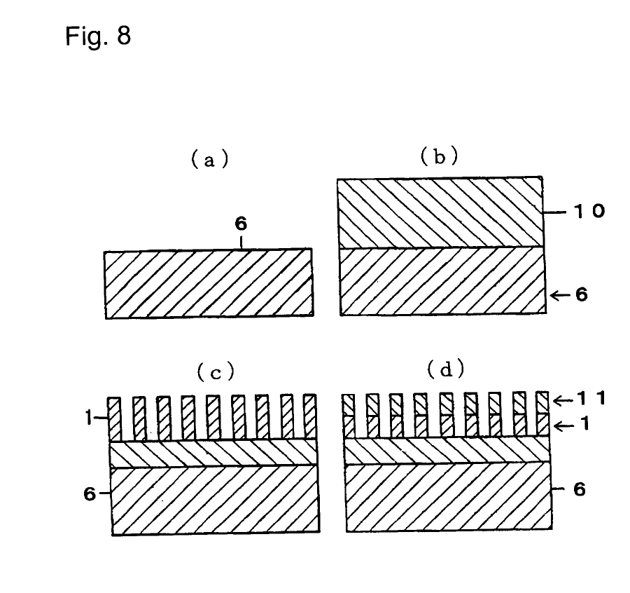

The anodized alumina used as a template is obtained by anodizing high purity aluminum. If necessary, such obtained anodized alumina is subjected to a suitable treatment to make the anodized alumina be a penetrating pore. Furthermore, in the method of preparing a nano-hole array with a substrate as shown in FIG. 8, high purity aluminum is subjected to vapor precipitation on the substrate 6 to form the aluminum layer 10, and its main surface is subjected to anodization, to prepare a template wherein anodized alumina layer 1 is formed on the aluminum layer 10 (FIG. 8(c)), the template is immersed into the solution described below to substitute the anodized alumina 1 with the target oxide 11, to give the nano-hole array with a substrate as shown in FIG. 8D. Furthermore, when preparing a nano-rod array of oxide with a substrate, the above-mentioned template may be also used.

(2) Adjustment of Aqueous Fluoride Complex Ion Solution

A fluoride complex solution comprising the target metal was prepared, which has a concentration of 0.1 mmol/l to 0.5 mol/l. Typical methods for the adjustment are following three methods.

1) (NH₄)₂MF₆ (wherein the formula is a general formula when M is converted to tetra-valent, wherein M represents one of transition metal elements, group IA elements, group IIA elements, group IIIB elements, group IVB elements, group VB elements or group VIB elements.) is dissolved in pure water, and adjusted to a suitable concentration to give an aqueous fluoride complex ion solution.

2) MOOH (wherein the formula is a general formula when M is converted to tri-valent, wherein M represents one of transition metal elements, group IA elements, group IIA elements, group IIIB elements, group IVB elements, group VB elements or group VIB elements) or MO_{c} (c is the number of oxygen atoms) is dissolved in NH₄F—HF 1.0 mol/l and saturated. Then, the solution is diluted to a suitable concentration to give an aqueous fluoride complex ion solution.

3) MF_{d} (d is the number of fluorine atoms) is dissolved in pure water, and adjusted to a suitable concentration to give an aqueous fluoride complex ion solution.

(3) Substitution Reaction

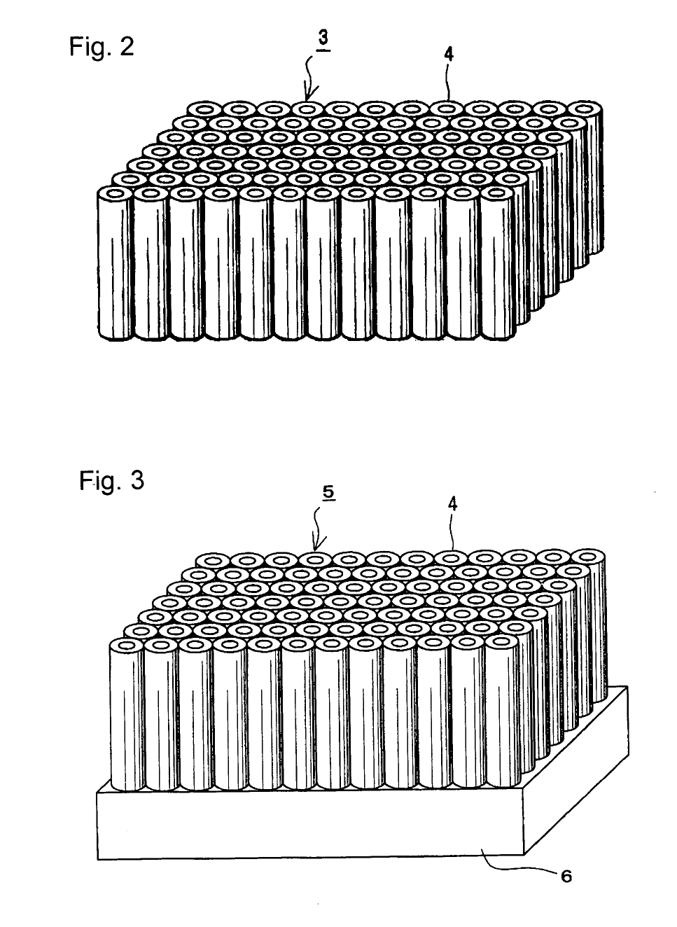

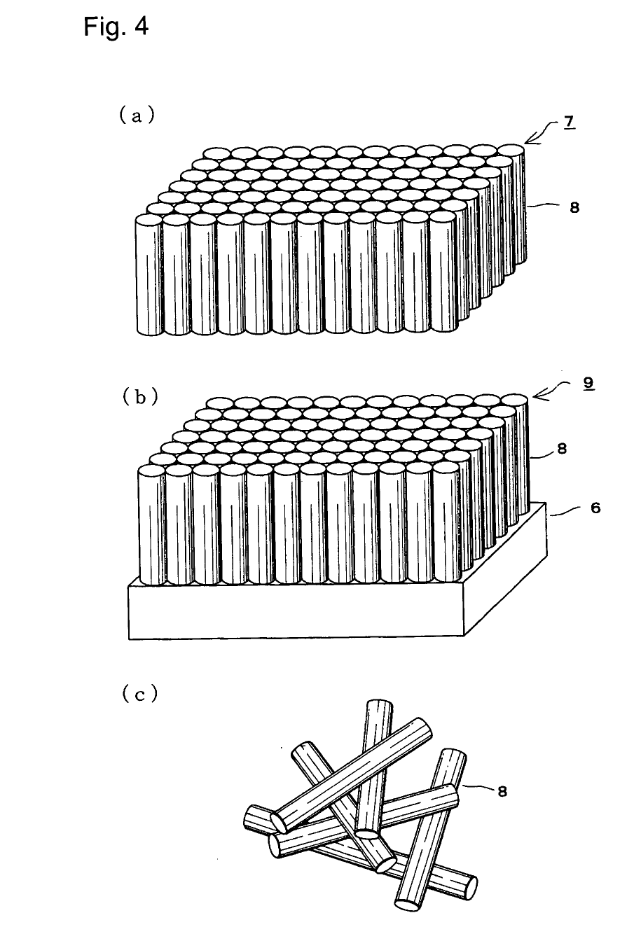

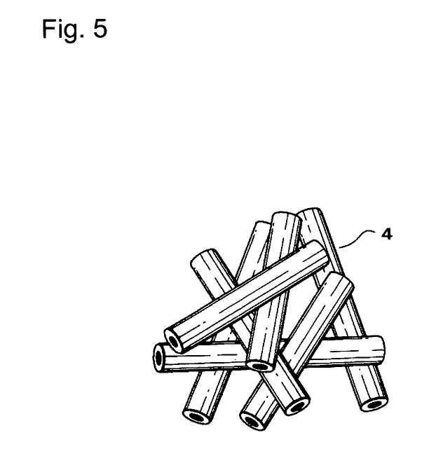

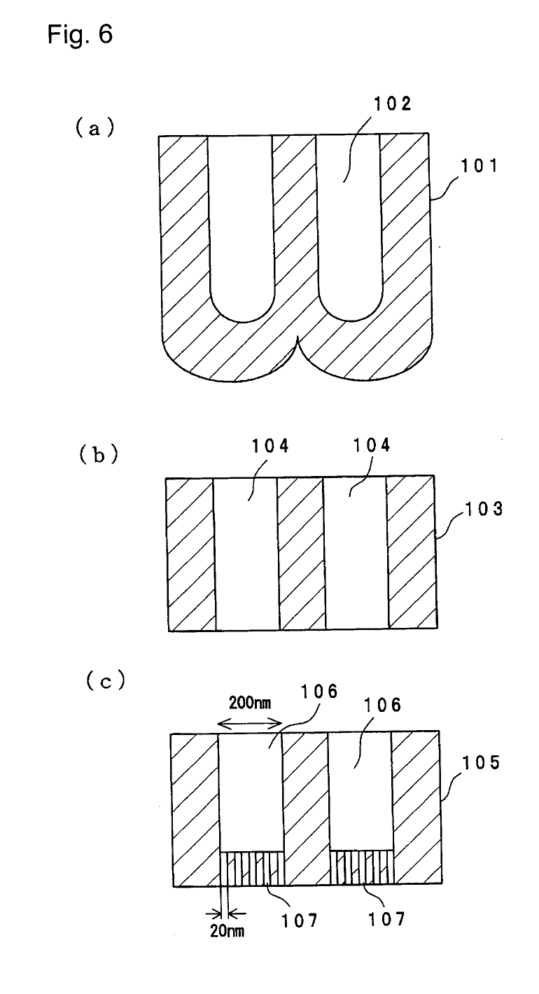

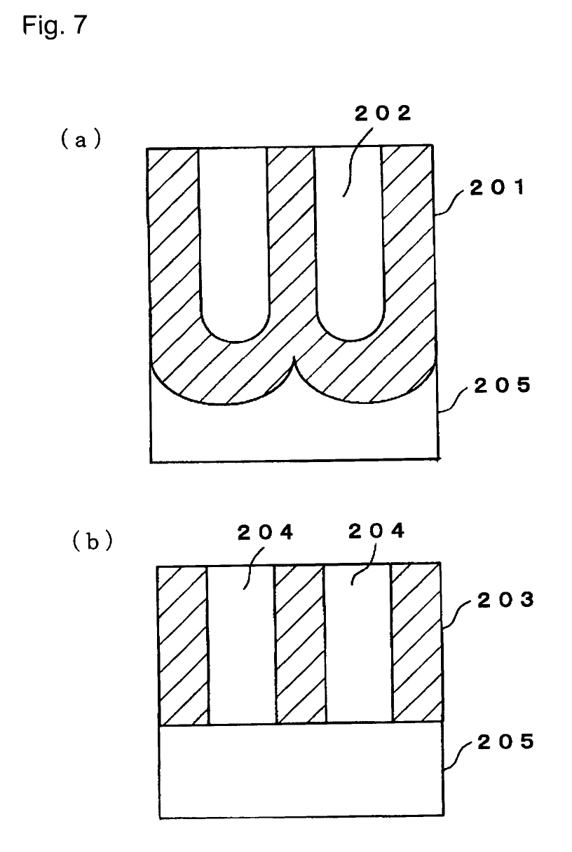

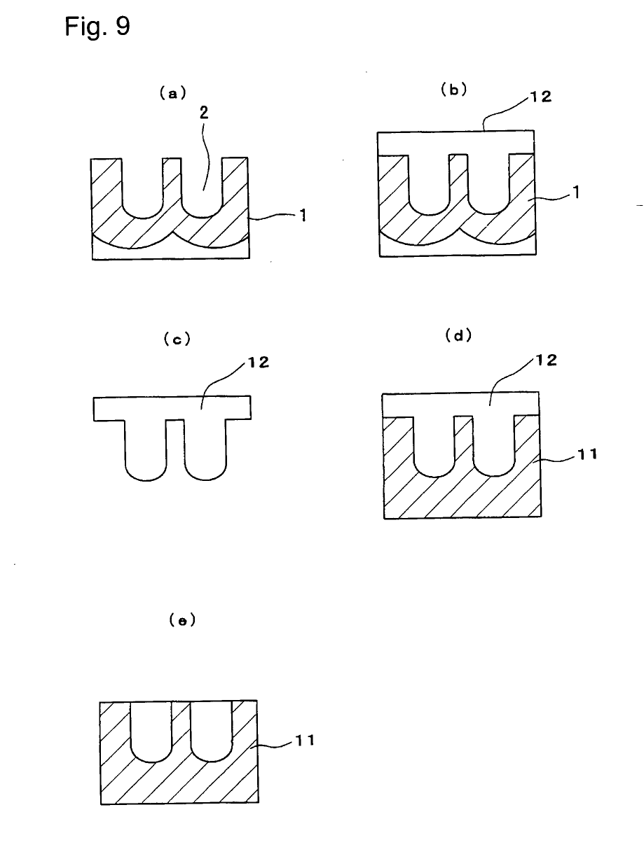

The substitution technique related to the invention includes a method wherein the precipitation reaction of the target oxide occurs at the same time as dissolution of the anodized alumina in an inorganic solution process. In the method of preparing the nano-rod of oxide, the precipitation reaction is predominant over the dissolution reaction, so the inner side of the hole is blocked to give a rod-shape body. In the conventional transcription technique, first, an organic substance 12 such as PMMA (polymethylmethacrylate) and the like is filled into pores 2 of template 1 (anodized alumina) as shown in FIG. 9(a) (FIG. 9(b)), then anodized alumina 1 is dissolved and the filling substance 12 is taken out (FIG. 9(c)). Again, the target substance 11 is injected and transcribed (FIG. 9(d)), and then PMMA 12 is dissolved (FIG. 9(e)) to give the target nano-structure of oxide 11. With this technique, it is required to repeat the same process a couple of times, but with the substitution technique according to the invention, it is possible to obtain a nano-structure wherein tubular bodies 4 or cylindrical bodies 8 are arranged like a bundle as shown in FIG. 2 or 3, by one process from the state of FIG. 9(a).

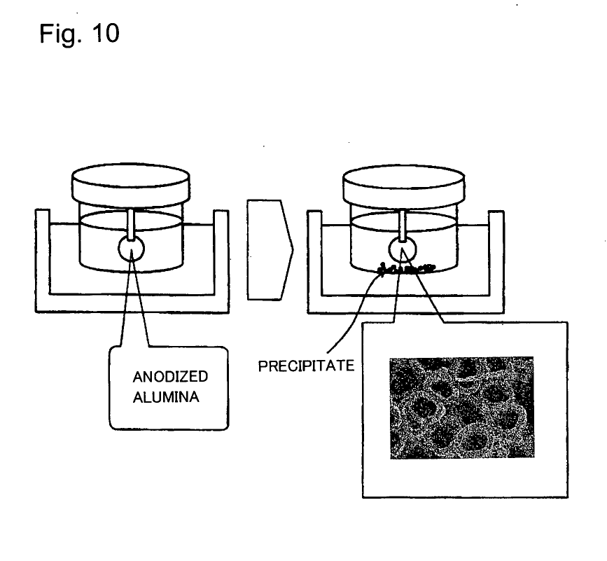

With FIG. 10, a method of preparing a nano-structure of oxide will be explained. The anodized alumina was soaked vertically into the above-mentioned aqueous fluoride complex ion solution. It was immersed for tens of minutes or several hours keeping suitable temperature as itself, to give a nano-hole array of oxide. An aqueous solution comprising an aqueous solution of a metal fluoride complex ion is in an equilibrium state of
MF₆²⁻+2H₂O [symbol] MO₂+4HF+2F⁻.

This formula consists of
a reaction of a fluoro complex with water:
   MF₆²⁻+4H₂O [symbol] M(OH)₄+4HF+2F⁻,
and, a reaction of dehydration to produce metal oxide:
   M(OH)₄→MO₂+2H₂O.

To shift this equilibrium to the right direction, dissolution reaction of the anodized alumina:
Al₂O₃+12F⁻+12H⁺→2H₃AlF₆+3H₂O
was used. As results, a part or the whole of the nano-structure layer made from the anodized alumina is substituted with the target oxide to give a nano-structure wherein nano-holes or nano-rods are arranged like a bundle.
(4) Separation Process

For a nano-structure wherein no substrate is arranged, it is also possible to make the nano-rod array which is arranged like a bundle, to nano-rods of independently separated state by dissolving remaining alumina in a desired solution. The above-mentioned solution may be acidic solution or alkali solution as long as it dissolves only the anodized alumina remaining around the target oxide without reacting with the target nano-structure of oxide finally obtained. A preferable solution is an aqueous solution of phosphoric acid. The concentration of the above-mentioned phosphoric acid aqueous solution is preferably 1 to 10% by weight, and more preferably 5% by weight or so. In this separation process, other methods may be used to separate the nano-structure, instead of the method by dissolution as described above.

(5) Post Treatment

The nano-structure is purified with ultrasonic wave for tens of seconds in pure water, and then purified with ultrasonic wave for tens of seconds in acetone. By this treatment, it is possible to remove the precipitate decomposed on the nano-hole array surface.

Constitution of Wet Solar Cell

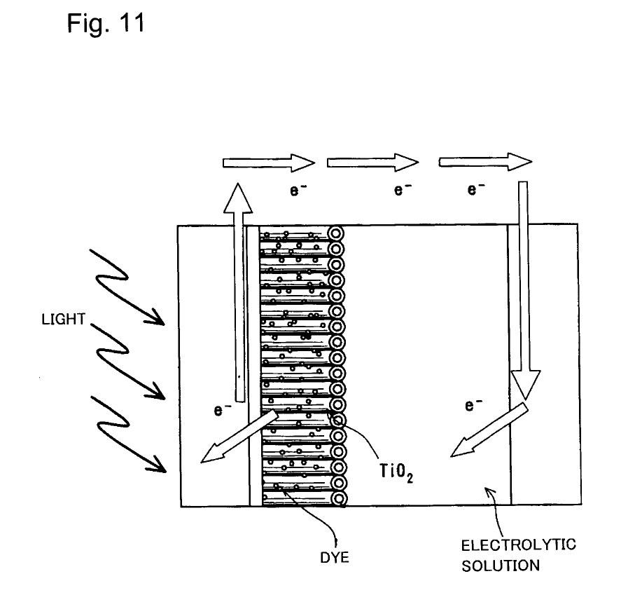

A schematic view of sensitizing dye solar cell is shown in FIG. 11. Generally, the structure has a negative electrode made by baking semiconductor powders such as TiO₂ and the like onto a transparent conductive glass plate, and further adsorbing a dye, a positive electrode of the same conductive glass plate, and electrolyte interposing between them. (1) If the light is injected to the cell, the dye absorbs the light, to emit the electron. (2) This electron shifts rapidly to the semiconductor TiO₂, and is transferred to the electrode, and the opposite electrode reduces the electrolyte. (3) The electrolyte is oxidized by giving electron to the dye, returning to the initial state again. By repeating the process of these (1) to (3), electricity is generated. With using a TiO₂ nano-structure instead of the TiO₂ powders for the negative electrode, it is possible to improve largely the contact area between the electrode and the electrolyte, leading to good photovoltaic conversion efficiency.

Material for Photocatalyst

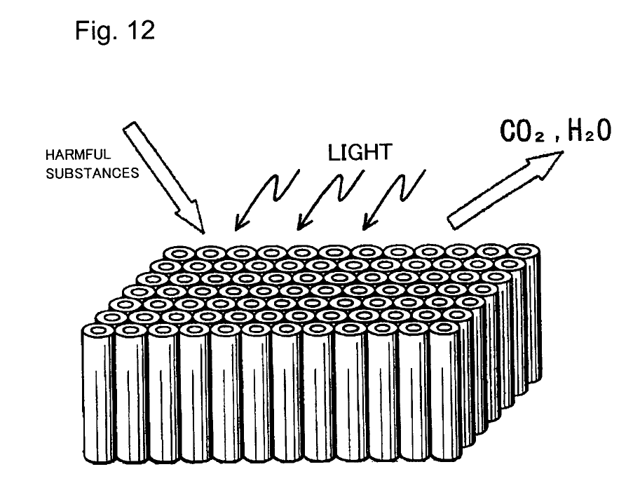

A schematic view of a material for a photocatalyst is shown in FIG. 12. If the light is injected to TiO₂, a pair of electron and hole is produced. By emitting the electron and hole into the outside, a redox reaction occurs. Thereby, it is also possible to decompose harmful substances and the like into CO₂, H₂O and the like. With using a TiO₂ nano-structure, the area for TiO₂ to absorb the light increases, leading to good degradation efficiency.

Material for Thermoelectric Conversion

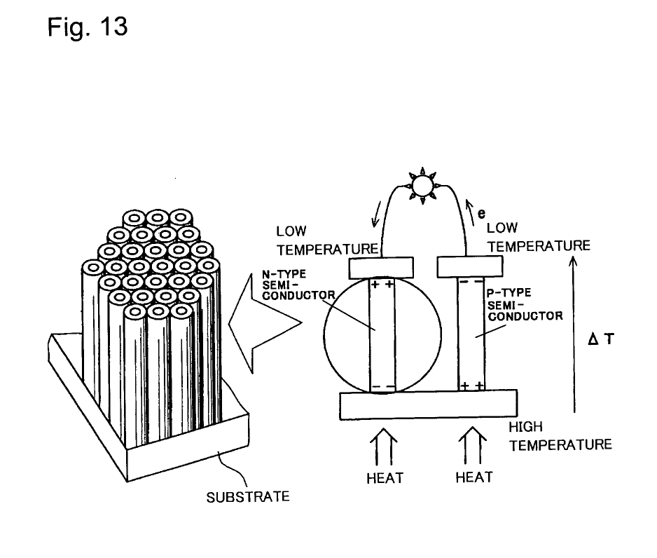

A schematic view of a material for thermoelectric conversion is shown in FIG. 13. The material for thermoelectric conversion refers to a material which directly converts heat to electricity using Seebeck effect. By giving temperature difference on both ends of a p-type semiconductor and an n-type semiconductor, respectively, electrical deviation is generated in the semiconductor, which makes it possible to generate a thermoelectromotive force.

To improve performance of the material for thermoelectric conversion, it is required to have high electrical conductivity and Seebeck coefficient and low thermal conductivity in combination at the same time. If a complex material can be developed wherein metal element is filled in the hole of the nano-hole array of oxide, it is possible to obtain high Seebeck coefficient in the oxide part, and high electrical conductivity in the metal part. Furthermore, with the wall thickness of the nano-hole arrays of oxide as single nano size, the electricity carrier makes it possible to scatter only phonon as it is, and further makes it possible to largely reduce lattice thermal conductivity. The kind of the nano-hole array of oxide is ideally ZnO showing high performance even in a bulk material, but even with other oxide such as TiO₂ and the like, it is possible to obtain high performance if efficient electrical conductivity can be achieved at the filled metal part. A nano-hole array of oxide with a substrate may be also used as the nano-hole array of oxide.

Li Ion Battery

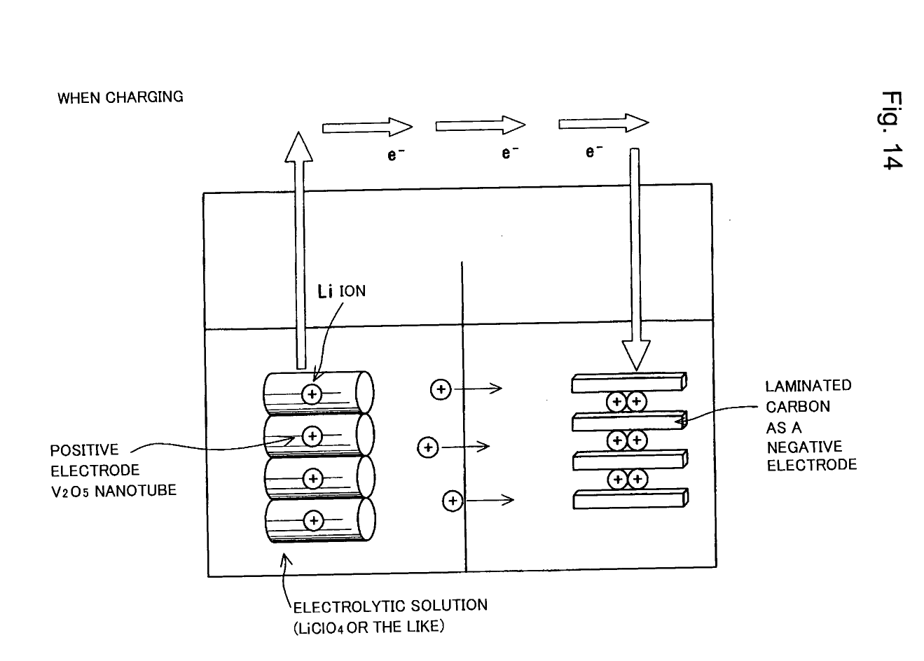

A schematic view of a Li ion battery is shown in FIG. 14. The Li ion battery conducts charge and discharge by reacting the positive electrode material and the negative electrode material with Li ion of the electrolyte. FIG. 14 shows an example of the Li ion battery wherein V₂O₅ nano-hole array is used as a positive electrode, laminated carbon as a negative electrode, and LiClO₄ and the like as an electrolytic solution, respectively. With using the V₂O₅ nano-hole array as a positive electrode, the reaction area with the electrolyte increases, leading to increased energy density.

Fuel Cell

The constitution unit of the fuel cell is a single cell wherein electrolyte is interposed between two electrodes. Though the cell can be classified into several types according to the kind of the electrolyte to be used, it can be applied to a fuel cell of solid oxide. As an electrolyte of the fuel cell of solid oxide, a thin film of ZrO₂—Y₂O₃ (Yttria Stabilized Zirconia; YSZ) is used. It has a feature that it can be used at high temperatures without a catalyst since the electrolyte is oxide. The YSZ nano-hole array can be used as an electrolyte material of a fuel cell of solid oxide.

Material for Matrix Reinforcement

By mixing nano-rods in the resin, it is possible to use the nano-rods as a material for strength reinforcement. If the aspect ratio is increased, anisotropy of dispersion material is enhanced, leading to increased strength of the resin.

Micro-Injection, Micro-Operation and Micro-Adhesion

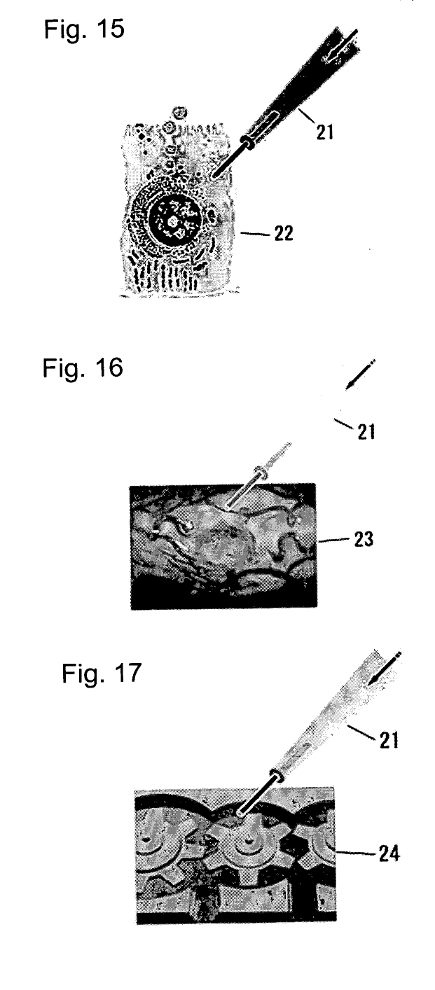

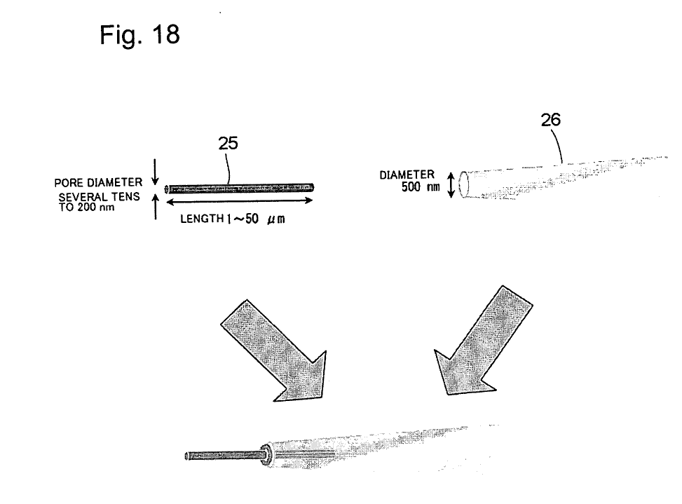

Conceptual views of micro-injection, micro-operation and micro-adhesion are shown in FIGS. 15 to 17. In the conceptual view of micro-injection in FIG. 15, 21 represents a nano-needle of oxide attached to a glass capillary, and 22 represents a cell. Furthermore, in the conceptual view of micro-operation in FIG. 16, 23 represents a lesion of a patient (organ), and in the conceptual view of micro-adhesion in FIG. 17, 24 represents a micro-machine. Herein, micro-injection refers to directly taking in/out the substances such as a gene and the like by manipulation of a single cell. Furthermore, micro-operation refers to operating an ultra-micro area such as an organ and the like which has a complicated and fine structure using a microscope and the like. Furthermore, micro-adhesion refers to applying a trace amount of adhesive to micro-area of a micro-machine. At present, used is a glass capillary of which the tip is processed to have up to about 500 nm of the pore diameter, as a tool for manipulating and processing the subject exactly or introducing a substance into a micro-area. However, it cannot be said that it is a suitable size in a specific field such as taking out or in gene and the like for single cell. Therefore, if the nano-needle of oxide 25 related to the invention which has 10 to 500 nm of the pore diameter is used as attached to the glass capillary 26 which has been conventionally used and has about 500 nm of the pore diameter (FIG. 18), correct cell manipulation can be carried out more accurately for “micro-injection”, pinpoint treatment for a smaller area is enabled, which reduces burdens for patients for “micro-operation”, and a trace amount of an adhesive can be applied correctly for “micro-adhesion”. The nano-needle of oxide can be prepared easily and cheaply in a short time.

### EXAMPLE 1

Preparation of SnO₂ Nano-Hole Array

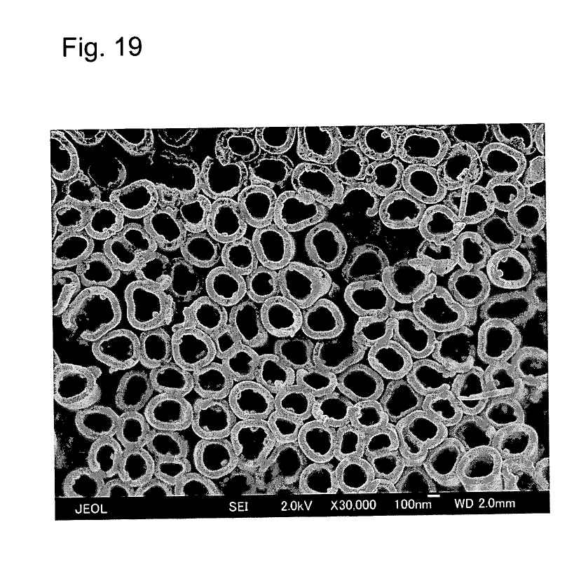

Anodized alumina (shape, dimension: 13φ disc, manufactured by Whatman company, trademark: Anodisc) was prepared as a template. On the other hand, 0.1 mol/l of a tin fluoride complex solution was prepared with H₂O and (NH₄)₂SnF₆. The anodized alumina was immersed into the solution at 25° C. for 60 minutes, to give a nano-hole array wherein the anodized alumina of the template is substituted with SnO₂. FIG. 19 represents the SEM (scanning electron microscope) photograph.

### EXAMPLE 2

Preparation of TiO₂ Nano-Hole Array

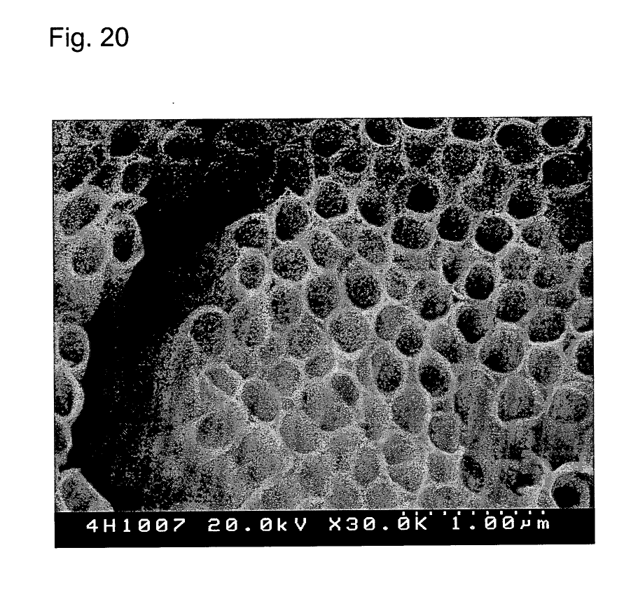

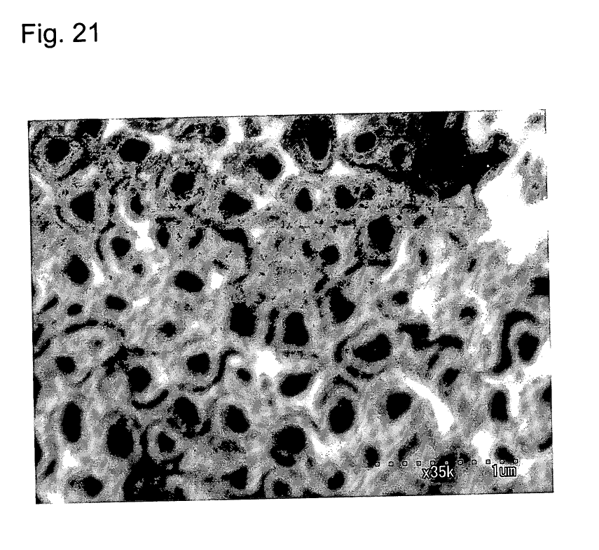

Anodized alumina (shape, dimension: 13φ disc, manufactured by Whatman company, trademark: Anodisc) was prepared as a template. On the other hand, 0.1 mol/l of a titanium fluoride complex solution was prepared with H₂O and (NH₄)₂TiF₆ The anodized alumina was immersed into the solution at 10° C. for 240 minutes, to give a nano-hole array wherein the anodized alumina of the template is substituted with TiO₂. FIG. 20 shows the SEM photograph.

### EXAMPLE 3

Preparation of ZrO₂ Nano-Hole Array

Anodized alumina (shape, dimension: 13φ disc, manufactured by Whatman company, trademark: Anodisc) was prepared as a template. On the other hand, 0.05 mol/l of a zirconium fluoride complex solution was prepared with H₂O and (NH₄)₂ZrF₆. The anodized alumina was immersed into the solution at 25° C. for 120 minutes, to give a nano-hole array wherein the anodized alumina of the template is substituted with ZrO₂. FIG. 21 shows the SEM photograph.

### EXAMPLE 4

Preparation of FeOOH Nano-Hole Array

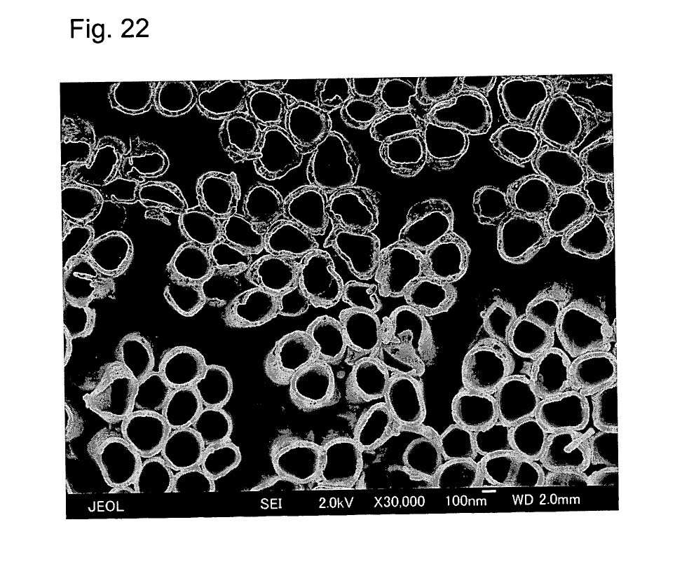

Anodized alumina (shape, dimension: 13φ disc, manufactured by Whatman company, trademark: Anodisc) was prepared as a template. On the other hand, 7 mmol/l of a iron fluoride complex solution was prepared with FeOOH and 0.1 mol/l of NH₄F.HF. The anodized alumina was immersed into the solution at 20° C. for 120 minutes, to give a nano-hole array wherein the anodized alumina of the template is substituted with FeOOH. FIG. 22 shows the SEM photograph.

### EXAMPLE 5

Preparation of ZnO Nano-Hole Array

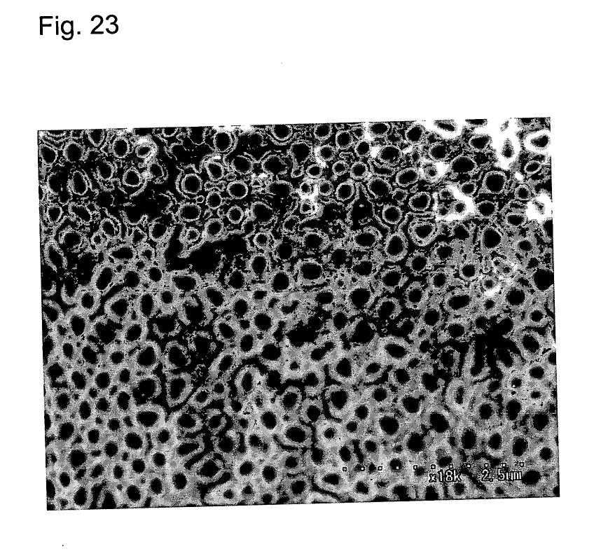

Anodized alumina (shape, dimension: 13φ disc, manufactured by Whatman company, trademark: Anodisc) was prepared as a template. On the other hand, 0.1 mol/l of a zinc fluoride complex solution was prepared with H₂O and ZnF₂. The anodized alumina was immersed into the solution at 20° C. for 120 minutes, to give a nano-hole array wherein the anodized alumina of the template is substituted with ZnO. FIG. 23 shows the SEM photograph.

### EXAMPLE 6

Preparation of TiO₂ Nano-Hole Array with a Substrate

The surface of the aluminum plate of 10 mm×30 mm×500 μm (thickness) was anodized with 200 V in the solution of 0.3 mol/l H₃PO₅ at 20° C. for 5 minutes, to give an aluminum plate of which the surfaces are coated with the anodized alumina (designated as Sample 1). Herein, the aluminum plate remaining not anodized is used as a substrate. On the other hand, H₂O and (NH₄)₂TiF₆ were combined to give 0.1 mol/l titanium fluoride complex solution (designated as Solution 1).

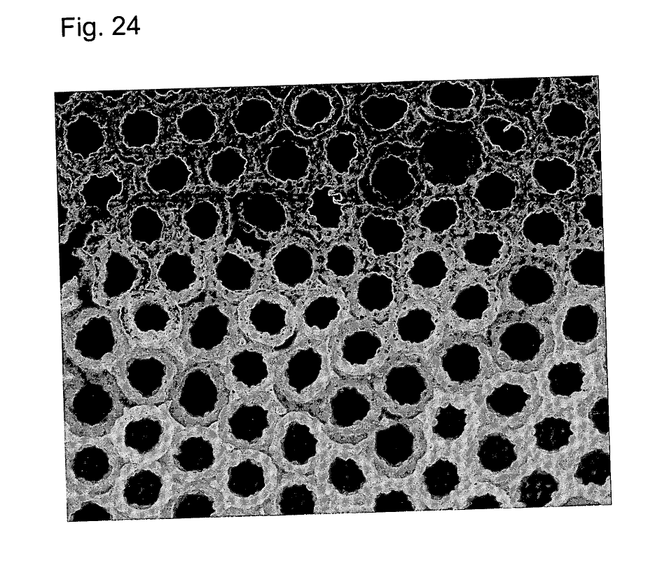

Sample 1 was immersed into Solution 1 at 20° C. for 120 minutes, to give TiO₂ nano-hole array with a substrate wherein aluminum oxide of the aluminum plate surface was substituted with TiO₂. FIG. 24 shows the SEM photograph.

### EXAMPLE 7

Preparation of SnO₂ Nano-Hole Array with a Substrate

A template was prepared in the same manner as in the above-mentioned Example 6. On the other hand, a tin fluoride complex solution was prepared with H₂O and (NH₄)₂SnF₆. The template was immersed into the solution, to give a nano-hole array with a substrate wherein the oxide alumina of the template was substituted with SnO₂.

### EXAMPLE 8

Preparation of ZrO₂ Nano-Hole Array with a Substrate

A template was prepared in the same manner as in the above-mentioned Example 6. On the other hand, a zirconium fluoride complex solution was prepared with H₂O and (NH₄)₂ZrF₆. The template was immersed into the solution, to give a nano-hole array with a substrate wherein the oxide alumina of the template was substituted with ZrO₂.

### EXAMPLE 9

Preparation of FeOOH Nano-Hole Array with a Substrate

A template was prepared in the same manner as in the above-mentioned Example 6. On the other hand, a iron fluoride complex solution was prepared with NH₄F.HF and FeOOH. The template was immersed into the solution, to give a nano-hole array with a substrate wherein the oxide alumina of the template was substituted with FeOOH.

### EXAMPLE 10

Preparation of ZnO Nano-Hole Array with a Substrate

A template was prepared in the same manner as in the above-mentioned Example 6. On the other hand, a zinc fluoride complex solution was prepared with H₂O and ZnF₂. The template was immersed into the solution, to give a nano thru-hole array with a substrate wherein the oxide alumina of the template was substituted with ZnO.

### EXAMPLE 11

Preparation of SnO₂ Nano-Rod

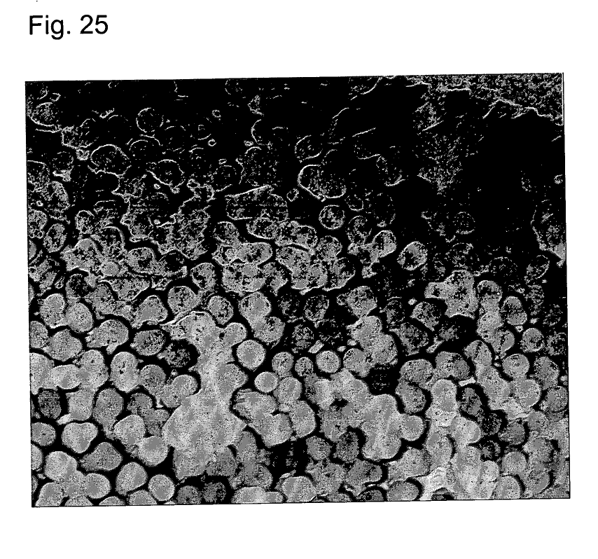

Anodized alumina (shape, dimension: 13φ disc, manufactured by Whatman company, trademark: Anodisc) was prepared as a template. On the other hand, 0.1 mol/l of a tin fluoride complex solution was prepared with H₂O and (NH₄)₂SnF₆. The anodized alumina was immersed into the solution at 60° C. for 30 minutes, to give a nano-rod array wherein the oxide alumina of the template was substituted with SnO₂. In the present Example, a scavenger was not mixed in. FIG. 25 shows the SEM photograph. Then, remaining alumina was dissolved in 5% by weight of an aqueous phosphoric acid solution to give a SnO₂ nano-rod.

### EXAMPLE 12

Preparation of TiO₂ Nano-Rod

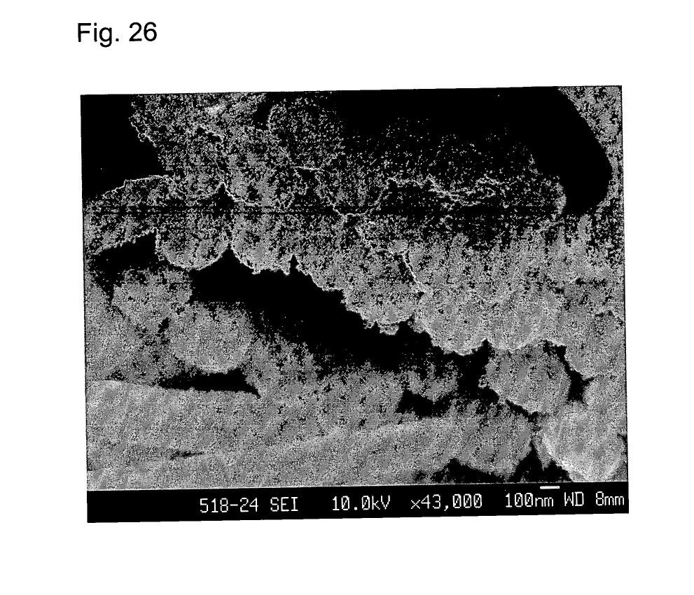

Anodized alumina (shape, dimension: 13φ disc, manufactured by Whatman company, trademark: Anodisc) was prepared as a template. On the other hand, 0.1 mol/l of a titanium fluoride complex solution was prepared with H₂O and (NH₄)₂TiF₆. The anodized alumina was immersed into the solution at 20° C. for 180 minutes, to give a nano-rod wherein the oxide alumina of the template was substituted with TiO₂. Herein, 0.1 mol/l of H₂BO₃ as a scavenger, was mixed in the titanium fluoride complex solution. FIG. 26 shows the SEM photograph. Then, remaining alumina was dissolved in 5% by weight of an aqueous phosphoric acid solution to give a TiO₂ nano-rod.

### EXAMPLE 13

Preparation of TiO₂ Nano-Rod

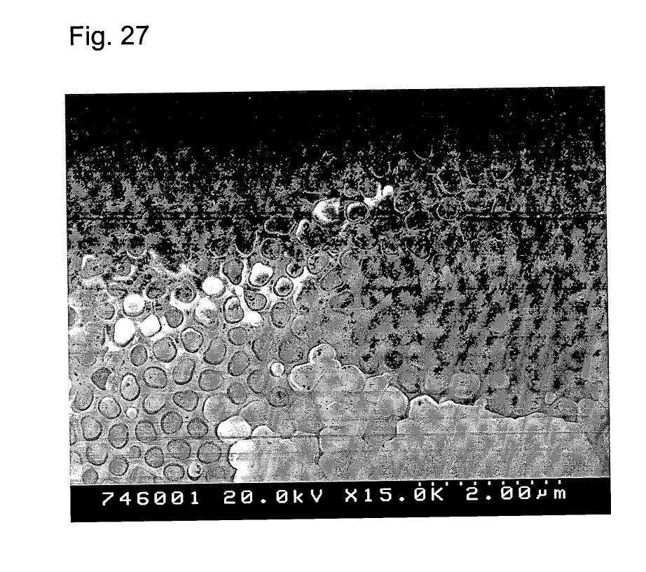

Anodized alumina (shape, dimension: 13φ disc, manufactured by Whatman company, trademark: Anodisc) was prepared as a template. On the other hand, 0.1 mol/l of a titanium fluoride complex solution was prepared with H₂O and (NH₄)₂TiF₆. The anodized alumina was immersed into the solution at 60° C. for 60 minutes, to give a nano-rod wherein the oxide alumina of the template was substituted with TiO₂. Herein, a scavenger was not mixed in the titanium fluoride complex solution. FIG. 27 shows the SEM photograph. Then, remaining alumina was dissolved in 5% by weight of an aqueous phosphoric acid solution to give a TiO₂ nano-rod.

### EXAMPLE 14

Preparation of ZnO Nano-Rod

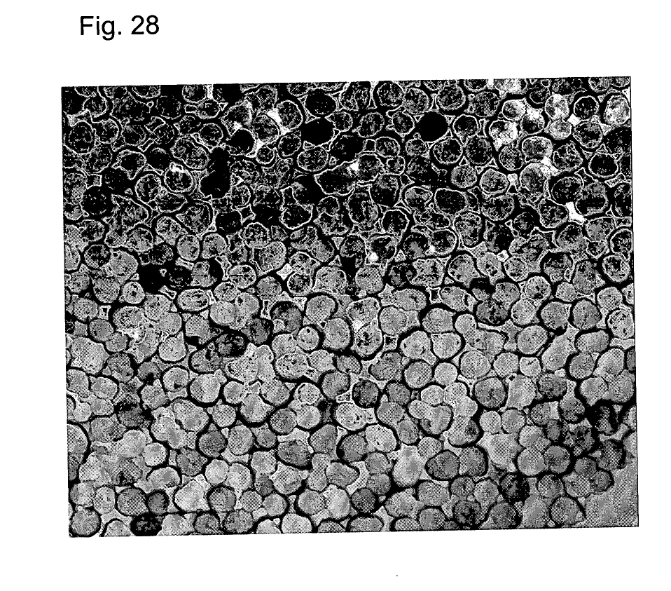

Anodized alumina (shape, dimension: 13φ disc, manufactured by Whatman company, trademark: Anodisc) was prepared as a template. On the other hand, 0.1 mol/l of a zinc fluoride complex solution was prepared with H₂O and ZnF₂. The anodized alumina was immersed into the solution at 25° C. for 120 minutes, to give a nano-rod wherein the oxide alumina of the template was substituted with ZnO. FIG. 28 shows the SEM photograph. Then, remaining alumina was dissolved in 5% by weight of an aqueous phosphoric acid solution to give a ZnO nano-rod.

### EXAMPLE 15

Preparation of ZrO₂ Nano-Rod

Anodized alumina (shape, dimension: 13φ disc, manufactured by Whatman company, trademark: Anodisc) was prepared as a template. On the other hand, 0.05 mol/l of a zirconium fluoride complex solution was prepared with H₂O and (NH₄)₂ZrF₆. The anodized alumina was immersed into the solution, to give a nano-rod wherein the oxide alumina of the template was substituted with ZrO₂. Then, remaining alumina was dissolved in 5% by weight of an aqueous phosphoric acid solution to give a ZrO₂ nano-rod.

### EXAMPLE 16

Preparation of TiO₂ Nano-Needle

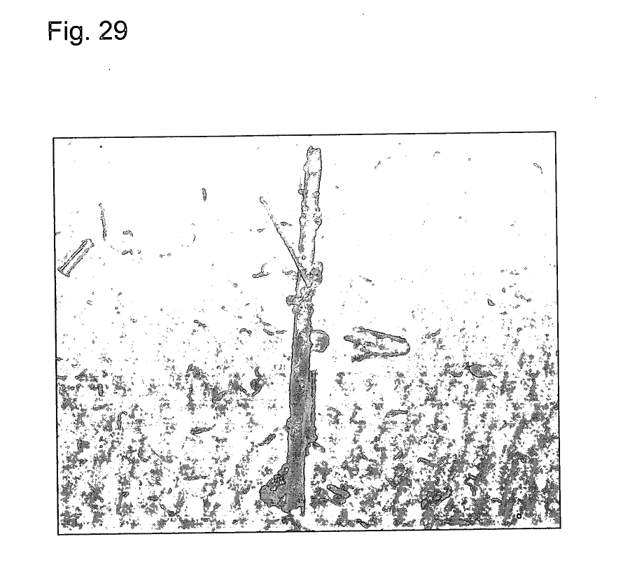

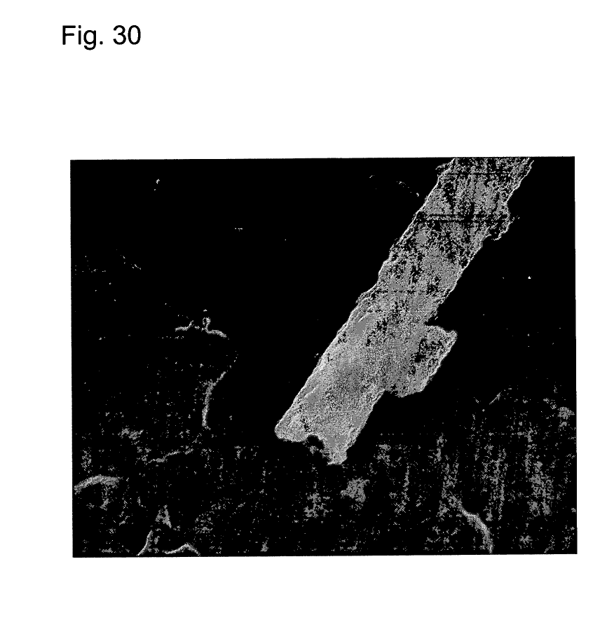

Anodized alumina (shape, dimension: 13φ disc, manufactured by Whatman company, trademark: Anodisc) was prepared as a template. On the other hand, 0.1 mol/l of a titanium fluoride complex solution was prepared with H₂O and (NH₄)₂TiF₆. The anodized alumina was immersed into the solution at 20° C. for 60 minutes, to give a nano-hole array wherein the oxide alumina of the template was substituted with TiO₂. Then, remaining alumina was dissolved in 5% by weight of an aqueous phosphoric acid solution to give a TiO₂ nano-needle. FIG. 29 shows the SEM photograph of TiO₂ nano-needle. Furthermore, FIG. 30 shows an enlarged SEM photograph thereof.

### EXAMPLE 17

Preparation of SnO₂ Nano-Needle

Anodized alumina (shape, dimension: 13φ disc, manufactured by Whatman company, trademark: Anodisc) was prepared as a template. On the other hand, a tin fluoride complex solution was prepared with H₂O and (NH₄)₂SnF₆. The anodized alumina was immersed into the solution, to give a nano-hole array wherein the oxide alumina of the template was substituted with SnO₂. Then, remaining alumina was dissolved in 5% by weight of an aqueous phosphoric acid solution to give a SnO₂ nano-needle.

### EXAMPLE 18

Preparation of ZnO Nano-Needle

Anodized alumina (shape, dimension: 13φ disc, manufactured by Whatman company, trademark: Anodisc) was prepared as a template. On the other hand, a zinc fluoride complex solution was prepared with H₂O and ZnF₂. The anodized alumina was immersed into the solution, to give a nano-hole array wherein the oxide alumina of the template was substituted with ZnO. Then, remaining alumina was dissolved in 5% by weight of an aqueous phosphoric acid solution to give a ZnO nano-needle.

The nano-hole array of oxide and the nano-hole array of oxide with a substrate related to the invention can be used for a material for saving, carrying and converting energy such as an electrode material for wet solar cell and lithium ion battery, a material for photocatalyst, a material for thermoelectric conversion, a material for hydrogen occlusion, various sensors, a material for photonic crystal, light emitting diodes and the like. Furthermore, it can be used as various filters, occlusion materials and catalyst for cell separation, separation and sterilization of medical gas, separation and degradation substances which is hard to be treated such as environmental hormone and the like, immobilization of NO_{X} and CO_{X}, separation and immobilization of FP (a fission product) gas, purification of various liquid wastes and the like.

Furthermore, nano-hole arrays of various oxides can be used as a bio-filter. For example, for the size of primary viruses, herpes virus has a diameter of 120 nm to 200 nm, vaccinia virus (smallpox vaccine) has a diameter of 200 nm to 300 nm, and influenza virus has a diameter of 80 nm to 120 nm. It can be said that the nano-hole array (about 200 nm of the pore diameter) has size suitable for separation of such virus.

Furthermore, for those having a photocatalyst function like a TiO₂ nano-hole array, a disinfection function by a photocatalyst can be also given in addition to the filter function. Thereby, it is possible to provide a filtering system which can remove all pathogenic microorganisms including bacteria and virus. Furthermore, the pore diameter of the nano-hole array is also suitable for incubation of various viruses. It is also useful as an incubator for incubating virus for experiment, specifically bioreactor. The nano-rod of oxide can be used as a strength reinforcement material which is used as mixed in the resin and the like. If the aspect ratio is increased, anisotropy of dispersion material is enhanced, leading to increased strength. Furthermore, by mixing functional nano-rod of oxide with a matrix, its function (for example, photocatalyst action for TiO₂) can be given to the matrix.

The nano-needle of oxide can be used for “micro-injection” in the bio-field, “micro-operation” in the medical field, and “micro-adhesion” in the field of semiconductor and mechanics. At present, used is a glass capillary of which the tip is processed to have up to about 500 nm of the pore diameter, as a tool for manipulating and processing the research subject exactly or introducing a substance into a micro-area. However, since the nano-needle of oxide related to the invention has 10 to 500 nm of the pore diameter, more correct and more accurate cell manipulation can be carried out for “micro-injection”, pinpoint treatment can be carried out for smaller areas, which reduces burdens for patients for “micro-operation”, and a trace amount of an adhesive can be applied correctly for “micro-adhesion”. The nano-needle of oxide can be prepared easily and cheaply in a short time.

1-64. (canceled)

65. A nano-structure of oxide or complex oxide of a metal element,
wherein the metal element is at least one selected from the group consisting of transition metal elements, group IA elements, group IIA elements, group IIIB elements, group IVB elements, group VB elements and group VIB elements and has an ability to compose a fluoride complex ion, and
wherein a stability constant of the metal fluoride complex is smaller than that of aluminum fluoride.

66. A nano-structure according to claim 65, wherein an aluminum template can be substituted by said fluoride complex ion.

67. A stacked nano-structure of oxide made from the first oxide or complex oxide of a metal element and the second oxide or complex oxide of a metal element,
wherein the metal element is at least one selected from the group consisting of transition metal elements, group IA elements, group IIA elements, group IIIB elements, group IVB elements, group VB elements and group VIB elements and has an ability to compose a fluoride complex ion, and
wherein a stability constant of the metal fluoride complex is smaller than that of aluminum fluoride.

68. The nano-structure according to claim 65, wherein the oxide or complex oxide comprises fine particles of metal.

69. The nano-structure according to claim 65, wherein aluminum oxide remains in an amount of 0.1 volume % or more, relative to the total oxide.

70. A nano-structure which is made by nitriding, reducing, and carbonizing the nano-structure of oxide according to claim 65.

71. The nano-structure according to claim 65, which is a nano-hole array wherein nano-holes which have penetrating pores of 50 μm or more, are arranged like a bundle.

72. The nano-structure according to claim 71, wherein the aspect ratio is 100 or more.

73. The nano-structure according to claim 65, which is a nano-hole array with a substrate, wherein the nano-holes are arranged like a bundle on at least one main surface of the substrate.

74. The nano-structure according to claim 73, wherein the length of the nano-hole is 1 μm or more.

75. The nano-structure according to claim 73, wherein the aspect ratio is 5 or more.

76. The nano-structure according to claim 73, wherein the substrate is electrically conductive metal or non-metal.

77. The nano-structure according to claim 65, which is a nano-rod of oxide.

78. The nano-structure according to claim 77, wherein the length of the nano-rod is 1 μm or more.

79. The nano-structure according to claim 77, wherein the aspect ratio is 5 or more.

80. The nano-structure according to claim 65, which is a nano-needle of oxide.

81. The nano-structure according to claim 80, wherein the length of the nano-hole is 1 μm or more.

82. The nano-structure according to claim 80, wherein the aspect ratio is 5 or more.

83. The nano-structure according to claim 80, wherein the inside diameter is 10 to 500 nm.

84. A method of preparing a nano-structure of oxide, which comprises:
a step of preparing a template which has a nano-structure and is made from oxide;
a step of preparing a solution which contains a fluoride complex ion of the metal element of the target oxide; and
a step of immersing the oxide template into the solution to substitute the oxide template with the target oxide.

85. The method of preparing a nano-structure of oxide according to claim 84,
wherein the target oxide is a metal element which is at least one selected from group consisting of transition metal elements, group IA elements, group IIA elements, group IIIB elements, group IVB elements, group VB elements and group VIB elements and has an ability to compose a fluoride complex ion, and
wherein the stability constant of the fluoride complex is smaller than that of aluminum fluoride.

86. The method of preparing a nano-structure of oxide according to claim 84, wherein the target oxide is the oxide of the metals, fluoride of which is soluble in the water and can be hydrolyzed, and the fluoride complex ion of which is unstable than the aluminum fluoride.

87. The method of preparing a nano-structure of oxide with a substrate according to claim 84, wherein the template is made from oxide and has a layer having nano-structure provided on at least one main surface of the substrate.

88. The method of preparing a nano-structure of oxide with a substrate according to claim 84, wherein the substrate is metal or non-metal.

89. The method of preparing a nano-structure of oxide with a substrate according to claim 84, wherein the template is used which has a layer of aluminum oxide having a nano-structure formed by anodization treatment (anodized alumina) on at least one main surface of an aluminum metal substrate.

90. The method of preparing a nano-structure of oxide according to claim 84, wherein the fluoride complex ion is in an aqueous solution at a concentration of 0.1 mmol/l or more.

91. The method of preparing a nano-structure of oxide according to claim 84, wherein the fluoride complex ion is prepared in which the fluoride complex is present in the form of MF_{X}^{Y-} (wherein M is a transition metal element, a group IA element, a group IIA element, a group IIIB element, a group IVB element, a group VB element or a group VIB element, x is the number of fluorine atoms and y is an valency).

92. The method of preparing a nano-structure of oxide according to claim 84, wherein the target oxide is formed via a hydroxide which is formed by hydrolysis of the fluoride complex ion in the solution.

93. The method of preparing a nano-structure of oxide according to claim 84, wherein the substitution reaction between the oxide of the template and the target oxide is carried out by a dissolution reaction of the oxide of the template and a precipitation reaction of the target oxide.

94. The method of preparing a nano-structure of oxide according to claim 84, wherein the substitution reaction is carried out in the range of 0 to 80° C. under atmospheric pressure.

95. The method of preparing a nano-structure of oxide according to claim 84, wherein the substitution reaction is carried out in the range of 5 to 40° C. under atmospheric pressure.

96. The method of preparing a nano-structure of oxide according to claim 84, wherein the substitution reaction comprises at least a first substitution reaction which is conducted in a solution comprising the first fluoride complex ion, and a second substitution reaction which is conducted in a solution comprising the second fluoride complex ion, which reactions are sequentially conducted, to prepare a nano-hole array of oxide wherein at least the first metal oxide and the second metal oxide are stacked.

97. The method of preparing a nano-structure of oxide according to claim 84, wherein the substitution reaction comprises a substitution reaction which is carried out in a solution comprising at least the first fluoride complex ion and the second fluoride complex ion, to prepare a nano-hole array of oxide comprising a complex oxide of at least the first metal oxide and the second metal oxide.

98. The method of preparing a nano-structure of oxide according to claim 84, wherein the substitution reaction comprises a substitution reaction which is carried out in a solution comprising at least one kind of fluoride complex ion and at least one kind of fine metal particles, to prepare a nano-hole structure of oxide comprising the fine metal particles.

99. The method of preparing a nano-structure of oxide according to claim 84, wherein the substitution reaction is carried out under any of light irradiation, radioactive ray irradiation and ultrasonic irradiation.

100. The method of preparing a nano-structure of oxide according to claim 84, wherein the template is used which comprises aluminum oxide having a nano-structure formed by anodization treatment (anodized alumina).

101. The method of preparing a nano-structure of oxide according to claim 84, wherein the template is used which has a structure in which pores are regularly extended on one surface.

102. The method of preparing a nano-structure of oxide according to claim 84, wherein the template is used which has a structure in which pores penetrates from one surface to the other surface.

103. The method of preparing a nano-structure of oxide according to claim 84, wherein the template is used which has a structure having pores of 200 nm diameter on one surface and having pores of 20 nm diameter on the other surface.

104. The method of preparing a nano-structure of oxide according to claim 84,
wherein the nano-structure is in the form of a nano-rod, and
wherein the substitution process is a reaction of substituting the oxide of the template with the target oxide by making the precipitation reaction rate of the target metal oxide greater than the dissolution reaction rate of anodized alumina.

105. The method of preparing a nano-structure of oxide according to claim 84, wherein the substitution reaction is carried out in the range of 20 to 80° C. under atmospheric pressure.

106. The method of preparing a nano-structure of oxide according to claim 84, wherein the substitution reaction is carried out under addition of a fluoride ion scavenger.

107. The method of preparing a nano-needle of oxide according to claim 84, which comprises a step of separating the nano-hole array of oxide into each of nano-holes of oxide (nano-needles).

108. A high-performance nano-hole array, which is a nano-hole array made from oxide or complex oxide of a metal element,
wherein the metal element is at least one selected from the group consisting of transition metal elements, group IA elements, group IIA elements, group IIIB elements, group IVB elements, group VB elements and group VIB elements and has an ability to compose a fluoride complex ion,
wherein the stability constant of the fluoride complex is smaller than that of aluminum fluoride, and
wherein the penetrating pores of the nano-holes, which have the length of 50 μm or more and the aspect ratio of 100 or more, are arranged like a bundle, or the nano-holes, which have bottoms and have the length of 1 μm or more and the aspect ratio of 5 or more, are arranged like a bundle on at least one main surface of the substrate.

109. The high-performance nano-hole array according to claim 108 responsive to visible light,
wherein the oxide is TiO₂, ZnO, SnO₂, SiO₂ or a mixture thereof, or a complex oxide thereof, and
wherein at least one selected from the group consisting of Ag, Pt and Cu fine particles is dispersed.

110. The nano-hole array according to claim 108 for photochromism, wherein the oxide is TiO₂ or SiO₂, and Ag is supported.

111. The nano-hole array according to claim 108 for an energy-saving photocatalyst, wherein WO₃ is supported in the nano-hole.

112. The nano-hole array according to claim 108 which is used for contacting the electrolyte in a dye sensitization type of a solar cell.

113. The nano-hole array according to claim 108 for a positive electrode of a lithium-ion battery, wherein the oxide is V₂O₅ or TiO₂.

114. The nano-hole array according to claim 108 for a material for thermoelectric conversion, wherein the oxide is ZnO or TiO.

115. The nano-hole array according to claim 108 for a material for thermoelectric conversion, wherein the oxide is ZnO, TiO₂, SnO₂, Fe₂O₃ or ZrO₂ and the nano-metal is embedded in the nano-hole.

116. The nano-hole array according to claim 108 for a gas sensor wherein the oxide is TiO, TiO₂, ZnO, SnO₂ or a mixture thereof, or a complex oxide thereof.

117. The nano-hole array according to claim 108 for a humidity sensor, wherein the oxide is SnO₂.

118. The nano-hole array according to claim 108 for an odor sensor, wherein the oxide is TiO, TiO₂, ZnO, SnO₂ or a mixture thereof, or a complex oxide thereof.

119. The nano-hole array according to claim 108 for a light sensor or a photonic crystal, wherein the oxide is TiO₂.

120. The nano-hole array according to claim 108 for a filter, wherein the oxide is oxide other than Al₂O₃.

121. The nano-hole array according to claim 108 for a material for CO₂ mobilization, wherein the oxide is represented by a formula MO_{b} (wherein M is Zr, Fe, Ni, Ti or Si and b is the number of oxygen atoms) or a formula LiₐMO_{b} (wherein M is Zr, Fe, Ni, Ti or Si, a is the number of lithium atoms, and b is the number of oxygen atoms).

122. The nano-hole array according to claim 108 for high-density memory media, wherein the oxide is a stacked oxide comprising any one of the combinations of Fe₂O₃ and ZrO₂, Fe₂O₃ and TiO₂, Fe₂₀₃ and SnO₂, Fe₃O₄ and ZrO₂, Fe₃O₄ and TiO₂, and Fe₃O₄ and SnO₂.

123. A nano-rod, which is separated, respectively, made from oxide or complex oxide of a metal element,
wherein the metal element is at least one selected from the group consisting of transition metal elements, group IA elements, group IIA elements, group IIIB elements, group IVB elements, group VB elements and group VIB elements and has an ability to compose a fluoride complex ion,
wherein the stability constant of the fluoride complex is smaller than that of aluminum fluoride, and
wherein the length of the nano-rod is 1 μm or more and the aspect ratio of the nano-rod is 5 or more.

124. The nano-rod according to claim 123 for a material for matrix reinforcement, wherein the oxide is TiO₂, ZnO, SnO₂, SiO₂ or a mixture thereof, or a complex oxide thereof.

125. The nano-rod according to claim 123 for a photocatalyst, wherein the oxide is TiO₂, ZnO, SnO₂, SiO₂ or a mixture thereof, or a complex oxide thereof.

126. A nano-needle for micro-injection, which is separated, respectively, made from oxide or complex oxide of a metal element,
wherein the metal element is at least one selected from the group consisting of transition metal elements, group IA elements, group IIA elements, group IIIB elements, group IVB elements, group VB elements and group VIB elements and has an ability to compose a fluoride complex ion and the stability constant of the fluoride complex is smaller than that of aluminum fluoride, and
wherein the length of the nano-needle is 1 μm or more and the aspect ratio is 5 or more.

127. The nano-needle for micro-injection according to claim 126, wherein the oxide is ZnO, TiO₂ or SnO₂.

128. The nano-needle for micro-operation according to claim 126, wherein the oxide is ZnO, TiO₂ or SnO₂.

129. The nano-needle for micro-adhesion according to claim 126, wherein the oxide is ZnO, TiO₂ or SnO₂.
